(19) United States
(12) Patent Application Publication
(10) Pub. No.: US 2026/0277553 A1
(43) Pub. Date: Sep. 17, 2026

(54) BELIEF SPACE MANAGEMENT FOR DIGITAL ARTIFACTS

(71) Applicant: Infosys Limited, Bangalore (IN)

(72) Inventors: Rajeshwari Ganesan, Bellevue, WA (US); Debrup Dey, Bengaluru (IN); Shubham Aggarwal, London (GB); Akshatha Miyal Kamath, Bengaluru (IN)

(73) Assignee: Infosys Limited, Bangalore (IN)

(21) Appl. No.: 19/369,792

(22) Filed: Oct. 27, 2025

Related U.S. Application Data
(60) Provisional application No. 63/771,444, filed on Mar. 13, 2025.

(51) Int. Cl. G06F 8/30

(52) U.S. Cl. CPC G06F 8/30

(57) ABSTRACT

A system for facilitating belief space management for digital artifacts is provided. The system includes a storage element and processing circuitry coupled thereto. The storage element stores a set of digital artifacts and a set of belief spaces associated with the set of digital artifacts. The processing circuitry detects an event associated with a digital artifact. The processing circuitry accesses, based on the detection of the event, a belief space associated with the digital artifact. The processing circuitry determines a plurality of attribute values for a plurality of attributes associated with the digital artifact. The processing circuitry identifies, from the belief space, a subset of belief types associated with the digital artifact. The subset of belief types is associated with a subset of belief states. The processing circuitry updates, based on the plurality of attribute values, the subset of belief states for the subset of belief types.

### CROSS-REFERENCE TO RELATED APPLICATIONS/INCORPORATION BY REFERENCE

This patent application refers to, claims priority to, and claims the benefit of U.S. provisional application no. 63/771,444, filed on Mar. 13, 2025, and entitled “LEGACY CODE MODERNIZATION”, the contents of which are hereby incorporated herein by reference in its entirety.

### FIELD OF THE DISCLOSURE

Various embodiments of the present disclosure relate generally to the management of belief spaces. More specifically, various embodiments of the present disclosure relate to artificial intelligence based management of belief spaces for digital artifacts.

### BACKGROUND

Across domains such as healthcare, finance, or manufacturing, organizations may rely on software products. The software products may be composed of numerous interacting components, such as digital artifacts, services, or the like, that operate in environments characterized by incomplete, uncertain, or dynamically changing information. To function effectively in such environments, these software products may typically maintain internal representations of external conditions, user goals, task progress, or contextual parameters. This internal representation is referred to as a belief space. The belief space may embody current understanding of the relevant aspects of operation or interaction associated with each digital artifact. Maintaining a belief space for a digital artifact within a software product may enable informed decision making about actions, resource allocation, or communications without having to re-compute all underlying conditions or dependencies from first principles at each decision point. Without such an internal representation, responses generated by a digital artifact would be limited to immediate inputs, reducing the ability to plan, adapt, or provide coherent behaviour over time.

Notably, the underlying environment and available information associated with each digital artifact are constantly changing. For example, new information may confirm, contradict, or refine previous assumptions. Similarly, previously acquired information may become obsolete or lose relevance as operational goals evolve. Therefore, the belief space of each digital artifact may need to be updated to remain accurate and useful. If a belief space of a digital artifact is not updated in a timely and consistent manner, the internal representation of the digital artifact may diverge from actual conditions, leading to degraded performance, increased latency, or erroneous outputs. Therefore, in software products comprising multiple interacting digital artifacts, updates across belief spaces may become important. A change in the belief space of one digital artifact may directly or indirectly affect the belief space of another digital artifact. For example, an update in one digital artifact’s internal representation of system state or user preferences may require corresponding changes in another digital artifact’s belief space to maintain consistency and accuracy.

Typically, existing approaches of propagating the changes across the digital artifacts may rely on manual configuration or predefined triggers. However, manual intervention may hinder the autonomous detection of digital artifacts requiring updates. Further, the manual intervention may increase latency and raise a risk of inconsistencies or errors across the software product.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems that facilitate belief space management for digital artifacts are provided substantially as shown in, and described in connection with, at least one of the figures.

In an embodiment of the present disclosure, a system is disclosed. The system comprises a storage element and processing circuitry that is communicably coupled to the storage element. The storage element is configured to store a set of digital artifacts and a set of belief spaces associated with the set of digital artifacts. A belief space of the set of belief spaces includes a set of belief types associated with a corresponding digital artifact of the set of digital artifacts and a set of belief states for the set of belief types. The processing circuitry is configured to detect an event associated with a first digital artifact of the set of digital artifacts. The processing circuitry is further configured to access, based on the detection of the event, a first belief space associated with the first digital artifact. The processing circuitry is further configured to determine a first plurality of attribute values for a first plurality of attributes associated with the first digital artifact. The first plurality of attribute values are indicative of first operational metadata for a set of operations associated with the event. The processing circuitry is further configured to identify, from the first belief space, a first subset of belief types associated with the first digital artifact. The first subset of belief types is associated with a first subset of belief states that is to be updated based on the event. The processing circuitry is further configured to update, based on the first plurality of attribute values, the first subset of belief states for the first subset of belief types.

In some embodiments, the storage element is further configured to store an event processing agent. The event processing agent is configured to monitor a second plurality of attribute values for the first plurality of attributes associated with the first digital artifact. The event processing agent is further configured to determine, based on the monitoring, a transition of the second plurality of attribute values to the first plurality of attribute values. The event is detected based on the transition of the second plurality of attribute values to the first plurality of attribute values.

In some embodiments, the storage element is further configured to store a belief state update agent. The belief state update agent is configured to receive, from the event processing agent, the first plurality of attribute values for the first plurality of attributes. The belief state update agent is further configured to determine, based on the first plurality of attribute values, the first operational metadata for the set of operations. The first subset of belief types is identified based on the first operational metadata.

In some embodiments, a first belief state of the first subset of belief states is indicative of a previous state of a first belief type of the first subset of belief types. The storage element is further configured to store a probability and confidence scoring agent configured to receive, from the belief state update agent, the first plurality of attribute values for the first plurality of attributes. The probability and confidence scoring agent is further configured to determine, based on the first plurality of attribute values, at least one of: a probability score associated with a current state of the first belief type or a confidence score associated with the probability score. The belief state update agent is further configured to receive, from the probability and confidence scoring agent, at least one of: the probability score associated with the current state of the first belief type or the confidence score associated with the probability score. The belief state update agent is further configured to update the first belief state based on at least one of: the probability score or the confidence score.

In some embodiments, the event is further associated with a second digital artifact of the set of digital artifacts. The processing circuitry is further configured to access, based on the detection of the event, a second belief space associated with the second digital artifact. The processing circuitry is further configured to determine a second plurality of attribute values for a second plurality of attributes associated with the second digital artifact. The second plurality of attribute values are indicative of second operational metadata for the set of operations associated with the event. The processing circuitry is further configured to identify, from the second belief space, a second subset of belief types associated with the second digital artifact. The second subset of belief types is associated with a second subset of belief states that is to be updated based on the event. The processing circuitry is further configured to update, based on the second plurality of attribute values, the second subset of belief states for the second subset of belief types.

In some embodiments, the storage element is further configured to store a dependency analysis agent. The dependency analysis agent is configured to identify a third belief space associated with a third digital artifact of the set of digital artifacts. The third belief space is identified based on an association of the third digital artifact with the first digital artifact. The processing circuitry is further configured to access the third belief space associated with the third digital artifact. The processing circuitry is further configured to determine a third plurality of attribute values for a third plurality of attributes associated with the third digital artifact. The third plurality of attribute values are indicative of third operational metadata for the set of operations associated with the event. The processing circuitry is further configured to identify, from the third belief space, a third subset of belief types associated with the third digital artifact. The third subset of belief types is associated with a third subset of belief states that is to be updated based on the event. The processing circuitry is further configured to update, based on the third plurality of attribute values, the third subset of belief states for the third subset of belief types.

In some embodiments, the association of the third digital artifact with the first digital artifact corresponds to at least one of: a syntactic association or a semantic association.

In some embodiments, the dependency analysis agent is further configured to create a dependency graph based on the set of belief spaces. The dependency graph is indicative of an association of the first belief space with the third belief space based on the first digital artifact being associated with the third digital artifact. The dependency analysis agent is further configured to determine the association of the third belief space with the first belief space based on the dependency graph.

In some embodiments, the first plurality of attributes corresponds to at least one of: a plurality of functional attributes associated with the first digital artifact, a plurality of non-functional attributes associated with the first digital artifact, or a plurality of hidden attributes associated with the first digital artifact.

In some embodiments, the processing circuitry is further configured to create a standard format file for the first digital artifact. The processing circuitry is further configured to determine a fourth plurality of attribute values for the first plurality of attributes associated with the first digital artifact. The processing circuitry is further configured to generate, for the first digital artifact, a structured file format based on at least one of: the standard format file and the fourth plurality of attribute values. The first belief space is created based on the generated structured file format. The processing circuitry is further configured to store the first belief space in the storage element.

In some embodiments, the storage element is further configured to store a set of logic constraints. The first subset of belief states is updated further based on the set of logic constraints.

In some additional embodiments, a method is disclosed. The method comprises detecting, by processing circuitry, an event associated with a first digital artifact of a set of digital artifacts. The set of digital artifacts is associated with a set of belief spaces with a belief space of the set of belief spaces including a set of belief types associated with a corresponding digital artifact of the set of digital artifacts and a set of belief states for the set of belief types. The set of digital artifacts and the set of belief spaces are stored in a storage element. The method further comprises accessing, by the processing circuitry, based on the detection of the event, a first belief space associated with the first digital artifact. The method further comprises determining, by the processing circuitry, a first plurality of attribute values for a first plurality of attributes associated with the first digital artifact. The first plurality of attribute values are indicative of first operational metadata for a set of operations associated with the event. The method further comprises identifying, by the processing circuitry, from the first belief space, a first subset of belief types associated with the first digital artifact. The first subset of belief types is associated with a first subset of belief states that is to be updated based on the event. The method further comprises updating, by the processing circuitry, the first subset of belief states for the first subset of belief types based on the first plurality of attribute values.

In another embodiment of the present disclosure, a computer-readable medium is disclosed. The computer-readable medium includes instructions that, when executed by processing circuitry of a computing system, cause the computing system to perform a method for management of belief spaces for digital artifacts. The method comprises detecting an event associated with a first digital artifact of a set of digital artifacts. The set of digital artifacts is associated with the set of belief spaces with a belief space of the set of belief spaces including a set of belief types associated with a corresponding digital artifact of the set of digital artifacts and a set of belief states for the set of belief types. The set of digital artifacts and the set of belief spaces are stored in a storage element. The method further comprises accessing, based on the detection of the event, a first belief space associated with the first digital artifact. The method further comprises determining a plurality of attribute values for a plurality of attributes associated with the first digital artifact. The plurality of attribute values are indicative of operational metadata for a set of operations associated with the event. The method further comprises identifying from the first belief space, a first subset of belief types associated with the first digital artifact. The first subset of belief types is associated with a first subset of belief states that is to be updated based on the event. The method further comprises updating the first subset of belief states for the first subset of belief types based on the plurality of attribute values.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 illustrates a schematic diagram of a system environment of a belief space management system, consistent with disclosed embodiments of the present disclosure;

FIG. 2 is a block diagram that illustrates the belief space management system, consistent with disclosed embodiments of the present disclosure;

FIG. 3 is a schematic diagram that illustrates a process flow for an exemplary implementation of the belief space management system, consistent with disclosed embodiments of the present disclosure;

FIGS. 4A-4O, collectively, illustrate examples of a first plurality of attribute values included within a structured file format associated with a first digital artifact, consistent with disclosed embodiments of the present disclosure;

FIGS. 5A and 5B, collectively, illustrate examples of a first set of belief states associated with a first set of belief types, consistent with disclosed embodiments of the present disclosure;

FIG. 6 represents a flowchart that illustrates a method for updating a first subset of belief states for a first subset of belief types associated with the first digital artifact, consistent with disclosed embodiments of the present disclosure; and

FIG. 7 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Currently, nearly every domain, such as healthcare, finance, manufacturing, or the like, may rely on software products as a foundation for operations. The software products may be composed of numerous interacting components such as digital artifacts, services, or the like. These components may typically operate in environments characterized by incomplete, uncertain, or dynamically changing information.

To function effectively under such conditions, software products may often maintain internal representations of external factors, including environmental states, user goals, task progress, and contextual parameters. This internal representation, referred to as a belief space, may capture a current understanding of relevant operational or interactional aspects associated with each digital artifact. Maintaining a belief space for a digital artifact within a software product may enable informed decision making about actions, resource allocation, or communications without having to re-compute all underlying conditions or dependencies from first principles at each decision point. Without such an internal representation, a response generated by a digital artifact would be limited to immediate inputs, thereby reducing the ability to plan, adapt, or exhibit coherent behaviour over time.

Notably, the underlying environment and available information associated with each digital artifact are constantly changing. Consequently, the belief space of each digital artifact may need to be updated to remain accurate and useful. If updates associated with the belief spaces are delayed or inconsistent, the internal representation of the digital artifacts may diverge from actual system conditions, leading to degraded performance, increased latency, or erroneous outputs. Therefore, in software products composed of multiple interacting digital artifacts, maintaining consistency across belief spaces may become important. A change in one digital artifact’s belief space, for example, as an update to system state or user preferences, may directly or indirectly affect the belief spaces of other digital artifacts.

Existing approaches to propagating such changes may often depend on manual configuration or predefined triggers. While functional, these methods may hinder autonomous detection of digital artifacts requiring updates and may introduce latency, inconsistencies, or human error across the system.

The present disclosure addresses the abovementioned limitations by providing a system (hereinafter, a belief space management system) and a method that leverages concepts of artificial intelligence (AI) (for example, generative AI and agentic AI) to facilitate belief space management associated with a set of digital artifacts. The system disclosed herein includes a storage element configured to store the set of digital artifacts and a set of belief spaces associated with the set of digital artifacts. The storage element is further configured to store a set of agents that facilitate the belief space management. The storage element is further configured to store a set of logic constraints based on which the belief space management may be facilitated by the set of agents.

Each digital artifact of the set of digital artifacts may correspond to a module of a software package. The module in the software package may refer to a distinct, self-contained unit of functionality that may contribute to the overall operation of the software package. Each module may typically encapsulate related functions, processes, or data structures, allowing the software package to be organized, maintained, and extended more efficiently. Further, each module may include an executable code (for example, a compiled binary script or a microservice), configuration files, or application programming interface, by way of which the module may communicate with other modules included within the software package. In an embodiment, each module may perform a defined subset of the overall functionalities associated with the software package, such as data processing, authentication, user interface (UI) rendering, logging, or the like.

A digital artifact of the set of digital artifacts may interact with one or more digital artifacts of the set of digital artifacts for implementation of a set of tasks associated with the software package. The set of tasks may refer to a collection of operations, processes, or computational functions associated with the software package, the execution of which may facilitate implementation of one or more functionalities of the software package. That is to say, the set of tasks may include various types of operations depending on the functionality of the software package. These tasks may be computational, functional, communicative, or administrative in nature. For example, in the case of computational tasks, the operations may include performing calculations, executing algorithms, or transforming data into different formats. Functional tasks may involve actions such as validating user input, managing user sessions, or controlling workflow execution within the software package. Communicative tasks may include exchanging data or messages with a system that is external to the system on which the software package may be deployed, invoking external APIs, or transmitting information across networked modules. Administrative tasks may include operations such as logging events, managing configuration parameters, handling errors, or monitoring system performance of the system on which the software package may be deployed.

The software package may be a legacy software package or a modernized software package. For the sake of brevity, the software package is assumed to be the legacy software package. A legacy software package may be an outdated application that is in use because the legacy software package may support critical business operations, despite being built on old technologies that are difficult to maintain, integrate, or secure. The software package may include various code modules that may correspond to digital artifacts of the software package. Each digital artifact of the software package may be associated with a corresponding belief space. For a digital artifact, a belief space is a structured internal representation that is maintained by the system and captures the current understanding or assumptions of the system about a state of the digital artifact.

The belief space of the digital artifact may be created based on attribute values of various attributes associated therewith. These attributes may correspond to functional attributes, non-functional attributes, or hidden attributes. The functional attributes may define specific behaviours, functions, and features that the digital artifact may support. Non-functional attributes may relate to quality characteristics such as performance, security, maintainability, and reliability of the digital artifact. Hidden attributes may capture implicit data from developer interactions and usage patterns associated with the digital artifact. Attribute values of the functional attributes, the non-functional attributes, and the hidden attributes may be embedded in a structured file format such as a JavaScript Object Notation (JSON) file, an Extensible Markup Language (XML) file, or the like. The structured file format may be used by a belief generation technique executed by processing circuitry that is included within the system to generate the belief space of the digital artifact. The belief space may be indicative of a state of the digital artifact that may be assumed by the system to be true at a given instance of time. The belief space may include a plurality of belief types for a plurality of parameters associated with the digital artifact. The plurality of parameters may include performance hotspots, code smells, security risks, or the like. A plurality of parameter values for the plurality of parameters may be determined based on attribute values of one or more attributes associated with the digital artifact. Each parameter of the plurality of parameters may correspond to a belief type of the plurality of belief types included within the belief space. The plurality of belief types may be associated with a plurality of belief states thereof. A belief state may be indicative of a current operational status of the digital artifact with respect to a parameter corresponding to an associated belief type. The current operational status of the digital artifact indicated by the belief state may be assumed by the system to be true at a given time. The belief space of the digital artifact may be indicative of a current operational status of the digital artifact with respect to the plurality of parameters. The state of the digital artifact may be indicated by the plurality of belief states associated with the plurality of belief types.

In some embodiments, the belief space may be further indicative of configuration settings of the digital artifact, an operating mode of the digital artifact, a version or an update status of the digital artifact, performance metrics (for example, memory usage, response time, throughput) of the digital artifact, a security status (for example, vulnerabilities, access permissions, or like) associated with the digital artifact, dependency of the digital artifact with libraries, services, or other digital artifacts of the set of digital artifacts, developer interactions associated with the digital artifact, or the like.

Each belief state for each belief type in the belief space may further include a probability score indicative of a probability of the state indicated by the corresponding belief state being true. The belief state may further include a confidence score, which may be indicative of a metric with which the system may ensure that the probability score is correct.

The belief spaces of the digital artifacts may be maintained by the set of agents utilized by the processing circuitry. The set of agents may include an event processing agent, a belief space update agent, a dependency analysis agent, a probability and confidence scoring agent, and a visualization agent. The storage element may further store the set of logic constraints. The set of logic constraints may correspond to a repository of rules and algorithms utilized for updating the parameters associated with each belief space of the set of belief spaces. The processing circuitry may utilize the set of agents for management of the belief spaces for the digital artifacts.

Various events associated with the software package may cause changes in the digital artifacts. Such changes in the digital artifacts may cause changes in corresponding belief spaces by affecting the belief types and corresponding belief states. Such changes in the belief spaces may be tracked by the system by implementing belief space management for the software package. In an example, the belief space management may be performed in response to an event, for example, a code commit event, a code modification event, a code deletion event, or the like, that is being performed in association with the set of digital artifacts.

In operation, the processing circuitry may be configured to detect, by utilizing the event processing agent, an event associated with a first digital artifact. The event processing agent may be further configured to determine a plurality of attribute values for the plurality of attributes associated with the first digital artifact. For example, the event processing agent may be configured to determine the plurality of attribute values associated with the functional attributes, the non-functional attributes, and the hidden attributes associated with the first digital artifact. The plurality of attribute values may be indicative of operational metadata associated with the event. The operational metadata may correspond to descriptive data associated with various operations, processes, or the like that may have been executed during the event. The event processing agent may be further configured to update a first structured file format associated with the first digital artifact based on the plurality of attribute values of the plurality of attributes. The event processing agent may be further configured to communicate to the belief state update agent a prompt indicative of the detection of the event associated with the first digital artifact. The event processing agent may be further configured to communicate the plurality of attribute values to the belief state update agent.

The belief state update agent may be configured to determine operational metadata associated with the event based on the plurality of attribute values. In some embodiments, the belief state update agent may be configured to determine a plurality of parameter values of a plurality of parameters associated with the first digital artifact. The belief state update agent may be further configured to identify, based on an occurrence of the event associated with the first digital artifact, a first belief space from the set of belief spaces. The first belief space may be associated with the first digital artifact. The belief state update agent may be further configured to identify a first subset of belief types from a plurality of belief types associated with the first belief space. The first subset of belief types may be identified based on the operational metadata associated with the event. In some embodiments, the first subset of belief types may be identified based on the plurality of parameter values associated with the first digital artifact.

The first subset of belief types may be associated with a first subset of belief states. The belief state update agent may be further configured to communicate the plurality of attribute values to the probability and confidence scoring agent. The probability and confidence scoring agent may be further configured to determine, based on the plurality of attribute values, at least one of a probability score associated with a current state of each belief type of the first subset of belief types and a confidence score associated with the corresponding probability score. In an embodiment, the probability and confidence scoring agent may utilize the set of logic constraints for determining the probability and confidence scores. The probability and confidence scoring agent may be further configured to communicate the probability score and the confidence scores to the belief state update agent. The belief state update agent may be further configured to update the first subset of belief states based on at least one of the probability scores or the confidence scores.

The dependency analysis agent may be further configured to identify one or more digital artifacts from that set of digital artifacts that are associated with the event or the first digital artifact. For example, the dependency analysis agent may identify that a second digital artifact is associated with the event or the first digital artifact. Further, based on the association of the second digital artifact with the event or the first digital artifact, a second subset of belief states associated with a second subset of belief types from a second set of belief types, associated with the second digital artifact, may be updated in a manner similar to the update of the first subset of belief states. The visualisation agent may be further configured to present to one or more users associated with the software package, via corresponding user devices, the updated first subset of belief states.

The disclosed system offers significant advantages, including a dynamic and optimized approach in managing the belief spaces for the digital artifacts. The belief spaces are updated based on real-time attribute values associated with the digital artifact through specific computational processes executed by the processing circuitry. The processing circuitry creates a comprehensive and structured representation of attributes associated with a digital artifact by embedding functional, non-functional, and hidden attributes into a structured file format, which facilitates complex decision making through probabilistic reasoning algorithms and multi-dimensional dependency analysis.

The inclusion of the plurality of hidden attributes into the structured file formats may provide valuable insights into how developers interact with the digital artifact by capturing implicit behavioural data. This implementation leads to improved code quality metrics and more accurate decision making through enhanced belief state calculations.

The system may support automation and scalability through the implementation of agentic and generative AI-based agents that execute specific computational tasks, including event processing, dependency analysis, and probability scoring. The processing circuitry coordinates these agents to enable faster and more efficient management of belief spaces for the digital artifacts through sequential processing workflows and real-time belief state updates. The system may benefit from improved adaptability, as the belief space management tasks may be dynamically tuned or reconfigured without hardware limitations through the agentic and generative AI-based agents executing machine-readable instructions, allowing the system to maintain consistent performance across varying computational loads.

The set of logic constraints stored in the storage element may enable conflict resolution and facilitates probability and confidence score generation through predetermined algorithms. The probability and confidence scores may further aid decision-making operations executed by the processing circuitry.

The processing circuitry identifies impacted belief spaces based on dependency analysis performed by the dependency analysis agent, which enables maintaining the belief spaces of each digital artifact of the set of digital artifacts through automated propagation of updates across syntactic and semantic associations.

The belief space management system enables intelligent, agile, and resource-efficient management of belief spaces for the digital artifacts while providing superior computational performance, thereby delivering enhanced operational flexibility and system throughput.

### Figure description

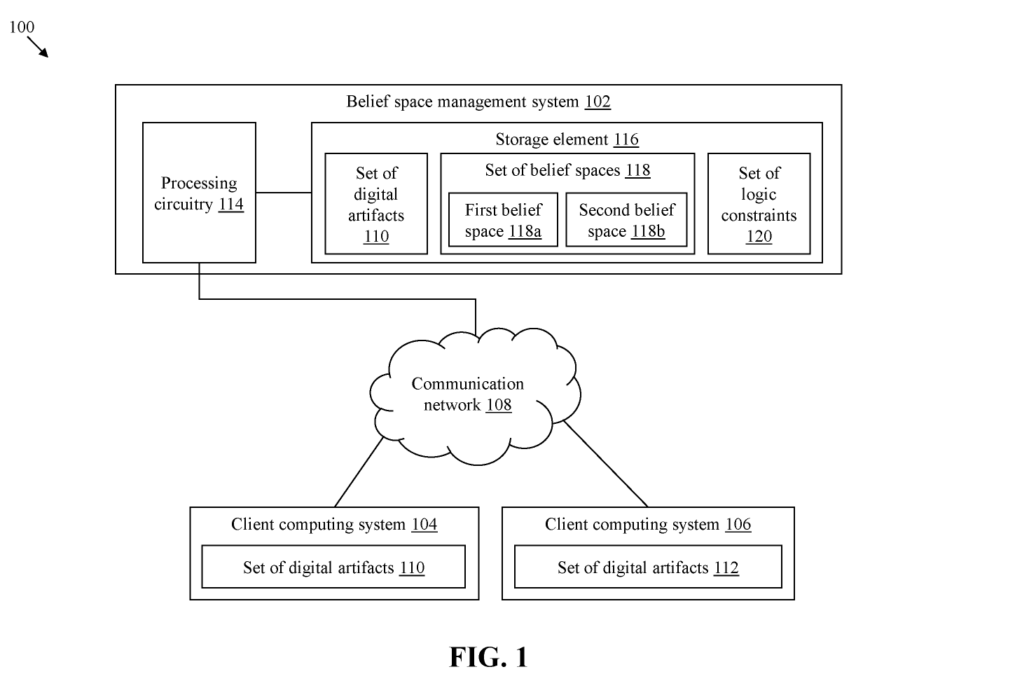

FIG. 1 illustrates a schematic diagram of a system environment 100 of a belief space management system, consistent with disclosed embodiments of the present disclosure.

Referring to FIG. 1, the system environment 100 is shown to include a belief space management system 102, a client computing system 104, and a client computing system 106. The client computing systems 104 and 106 may be associated with the belief space management system 102 via a communication network 108. The communication network 108 may facilitate communication between the client computing systems 104 and 106 and the belief space management system 102. Examples of the communication network 108 may include but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The client computing systems 104 and 106 may correspond to software-based systems that are deployed in a client environment to serve a specific operational or business need. Each of the client computing systems 104 and 106 may provide end-to-end solutions by hosting one or more software applications. Each of the client computing systems 104 and 106 may exist across diverse industries or domains and may vary in scale, complexity, and criticality.

For example, the client computing system 104 may correspond to an airline ticketing system. The client computing system 104 may be designed to manage flight reservations, scheduling, passenger records, payment processing, or the like. Similarly, the client computing system 106 may correspond to a hospital management system, and may be configured for handling patient registration, medical records, diagnostics scheduling, billing, or the like. In both cases, each of the client computing systems 104 and 106 may provide a domain-specific solution that may rely on software packages for the execution of tasks associated therewith.

In some embodiments, each of the client computing systems 104 and 106 may correspond to a software package that provides end-to-end solutions by hosting one or more software applications. The software package may be designed to serve specific operational or business needs and may exist across diverse industries, varying in scale, complexity, and criticality. The software package may include multiple code blocks, functions, services, routines, or similar components that, collectively, implement business logic for the corresponding client computing system (for example, the client computing systems 104 and 106)

In some embodiments, the software package may be associated with various domains such as airline ticketing systems, hospital management systems, financial services, logistics and fleet management, or manufacturing systems. For example, a software package associated with an airline ticketing system may include digital artifacts for flight scheduling, ticket booking, passenger check-in, payment processing, and customer notifications. Similarly, a software package associated with a hospital management system may include digital artifacts for patient intake, diagnostics, billing, and reporting.

A software package may typically consist of code blocks, functions, services, routines, or the like that may collectively implement business logic. These units of code may be grouped into a set of digital artifacts, where each digital artifact of the set of digital artifacts may represent a higher-level functional subdivision of the software package. For instance, the software package associated with the airline ticketing system may include a set of digital artifacts 110, each responsible for a specific functionality, such as flight scheduling, ticket booking, passenger check-in, payment processing, customer notifications, or the like. That is to say, a reservation artifact may handle seat availability, booking requests, cancellations, or the like.

Similarly, a payment artifact may handle processing transactions, refunds, integration with external payment gateways, or the like. Similarly, a check-in artifact may manage passenger verification, seat assignments, boarding pass generation, or the like. Similarly, a flight status artifact may handle updating departure times, delays, and cancellations. Similarly, a notification artifact may handle sending alerts to passengers via email or SMS regarding booking confirmations, gate changes, flight updates, or the like. The software package associated with the hospital management system may include a set of digital artifacts 112, each responsible for a specific functionality, such as patient intake, diagnostics, billing, reporting, or the like.

Notably, the software package associated with each of the client computing systems 104 and 106 may correspond to a legacy software package or a modern software package. However, for the sake of ongoing discussion, the software package is assumed to be the legacy software package. The legacy software package may refer to a software code that is inherited from an older version of a system or application. The software code may often be outdated and may not adhere to current coding standards or practices. In an example, the software code may be associated with an outdated technology, for example, Common Business-Oriented Language (COBOL) Programs, mainframe systems, Windows experience (Windows XP) Applications, Web applications built with outdated technologies like Adobe Flash or outdated versions of JavaScript frameworks (e.g., jQuery 1.x), and so on.

For the sake of brevity, the ongoing description is described with respect to the client computing system 104. It will be apparent to a person skilled in the art that belief space management for the digital artifacts associated with the client computing system 106 may be performed as described throughout the description.

The set of digital artifacts 110 may refer to a collection of software code modules or components that are implemented within the software package of the client computing system 104 to execute defined sets of tasks or functionalities. Each digital artifact in the set of digital artifacts 110 may correspond to a software code module.

The software code module or the digital artifact in the software package may refer to a distinct, self-contained unit of functionality that may contribute to the overall operation of the software package. Each digital artifact may typically encapsulate related functions, processes, or data structures, allowing the software package to be organized, maintained, and extended more efficiently. Further, each digital artifact may include an executable code (for example, a compiled binary script or a microservice), configuration files, or an application programming interface, by way of which the digital artifact may communicate with other digital artifacts included within the software package. In an embodiment, each digital artifact may perform a defined subset of the overall functionalities associated with the software package, such as data processing, authentication, user interface (UI) rendering, logging, or the like.

Each digital artifact of the set of digital artifacts 110 may be functionally interdependent on one or more digital artifacts within the set of digital artifacts 110, with dependencies existing in the form of shared data structures, interface contracts, service calls, or similar mechanisms. Each digital artifact may interact with the one or more digital artifacts to facilitate the implementation of tasks associated with the software package. Further, the set of tasks may refer to a collection of operations, processes, or computational functions associated with the software package, the execution of which may facilitate implementation of one or more functionalities of the software package. That is to say, the set of tasks may include various types of operations depending on the functionality of the software package. These tasks may be computational, functional, communicative, or administrative in nature. For example, in the case of computational tasks, the operations may include performing calculations, executing algorithms, or transforming data into different formats. Functional tasks may involve actions such as validating user input, managing user sessions, or controlling workflow execution within the software package. Communicative tasks may include exchanging data or messages with a system that is external to the system on which the software package may be deployed, invoking external APIs, or transmitting information across networked modules. Administrative tasks may include operations such as logging events, managing configuration parameters, handling errors, or monitoring system performance of the system on which the software package may be deployed.

Each digital artifact of the set of digital artifacts 110 may be associated with a plurality of attributes. The plurality of attributes may correspond to at least one of a plurality of functional attributes associated with the digital artifact, a plurality of non-functional attributes associated with the digital artifact, or a plurality of hidden attributes associated with the digital artifact.

The plurality of functional attributes may be indicative of functions associated with the digital artifact. For instance, the plurality of functional attributes may define specific behaviours, functions, and features that the digital artifact may support. The plurality of functional attributes may include call hierarchies. The call hierarchies may include details about function calls and dependencies associated with the digital artifact. The plurality of functional attributes may further include dependency information. For example, the dependency information may correspond to information about external libraries and test coverage associated with the digital artifact. The plurality of functional attributes may be directly related to the actions and operations associated with the digital artifact. Examples of the plurality of functional attributes may include, but are not limited to, user authentication, data processing, reporting, payment processing, function signatures, method definitions, parameter specifications, return types, class hierarchies, interface contracts, service calls, API endpoints, database queries, business logic implementation, workflow orchestration, and data validation routines.

The plurality of non-functional attributes associated with the digital artifact may be indicative of overall performance and user experience of a client computing system (for example, the client computing systems 104 and 106). The non-functional attributes may include static analysis metrics. The static analysis metrics may include code complexity measures like cyclomatic complexity. The non-functional attributes may further include code smells and anti-patterns, for example, identified potential issues associated with the digital artifact. The non-functional attributes may further include performance hotspots, security vulnerabilities, deprecated application programming interface (API) usage, scalability characteristics, usability metrics, reliability measures, or the like. Examples of the plurality of non-functional attributes may include, but are not limited to, response time measurements, memory usage patterns, CPU utilization metrics, throughput capacity, error rates, availability percentages, maintainability indices, code duplication levels, technical debt assessments, compliance violations, accessibility standards adherence, and load balancing efficiency.

The plurality of hidden attributes associated with the digital artifact may refer to data captured from the interaction of a developer with the digital artifact. For example, the developer interactions may include edits performed on the digital artifact, navigation patterns of the developer, co-edit frequencies associated with the digital artifact, or the like. The plurality of hidden attributes may be recorded implicitly. For example, how the developers may actually work with the digital artifact, rather than relying on direct user input or formal updates to documentation (for example, version control histories or code analysis reports) associated with the digital artifact. Therefore, the plurality of hidden attributes may be regarded as hidden, as the plurality of hidden attributes may reflect an inherent context of day-to-day interaction of the developer with the digital artifact. Further, the plurality of hidden attributes may include version control metadata, such as commit history, authorship, modification dates of the digital artifact, modification timestamp of the digital artifact, or the like. Examples of the plurality of hidden attributes may include, but are not limited to, edit frequency patterns, time spent reviewing code sections, debugging session durations, code search queries, file access sequences, collaboration patterns between developers, review comment frequencies, merge conflict resolution patterns, testing behaviour analytics, and implicit developer preferences derived from usage patterns.

Each digital artifact of the set of digital artifacts 110 may be associated with a belief space. That is to say, the set of digital artifacts 110 may be associated with a set of belief spaces. A belief space may be defined as a structured internal representation that captures all possible perceptions, estimates, or probability-based representations of a plurality of parameters associated with the digital artifact.

The plurality of parameters may include configuration settings of the digital artifact, operating mode of the digital artifact, version or update status of the digital artifact, performance metrics (for example, memory usage, response time, throughput) of the digital artifact, errors associated with the digital artifact, security status (for example, vulnerabilities, access permissions) of the digital artifact, dependencies of the digital artifact with libraries, services, or other digital artifacts of the set of digital artifacts 110, developer interactions associated with the digital artifact, or the like.

Notably, each of these parameters may be associated with at least one attribute of the plurality of attributes associated with the digital artifact. The plurality of attributes may include functional attributes, non-functional attributes, and hidden attributes as described herein. For example, the version or update status may be associated with the plurality of functional attributes, detection of vulnerabilities may be associated with the plurality of non-functional attributes, and developer interaction may be associated with the plurality of hidden attributes. Each parameter of the digital artifact may correspond to a specific belief type associated with the corresponding digital artifact. That is to say, each attribute of the plurality of attributes may correspond to a belief type. For example, each of security, performance, code maintainability, code smells, code commits, or the like, may correspond to a specific belief type.

A belief type may be defined as a categorical representation of a particular aspect or dimension of a state associated with a digital artifact, such as a security vulnerability, a performance hotspot, or a refactoring candidate. Thus, the belief space may include a set of belief types. Further, each belief type of the set of belief types may be associated with a belief state. A belief state may be defined as a probabilistic representation that indicates a current operational or functional status of a corresponding belief type. The belief state may include probability scores indicating the likelihood of a particular condition being true and confidence scores indicating the certainty of that assessment. For example, a belief state for a security vulnerability belief type may indicate a probability of 0.75 that a vulnerability exists with a confidence score of 0.90, reflecting both the likelihood of the security issue and the certainty of the system in that assessment.

The belief space of the digital artifact may be created based on attribute values of various attributes associated therewith. The attribute values may be determined from different parameters of the code module corresponding to the digital artifact. These parameters may include structural elements, operational characteristics, and behavioural patterns that define the functionality and performance of the digital artifact within the software package. The attribute values may be derived from parameters associated with functional attributes, non-functional attributes, and hidden attributes of the digital artifact.

The relationship between code module parameters and attribute values may be established through analysis implementation and runtime behaviour of the digital artifact. For example, a performance hotspot attribute value may be determined based on parameter modification time, where frequent modifications to certain parameters within a specified time period may indicate areas of the code that require optimization attention. In some embodiments, if a particular functional parameter has been modified multiple times within a short duration, this may result in a higher attribute value for the performance hotspot attribute, suggesting that the corresponding code section may be experiencing performance issues or instability.

The attribute values may be derived from various code module parameters, including, but not limited to, execution frequency of functions, memory allocation patterns, input/output operations, database query execution times, API response times, error occurrence rates, and resource utilization metrics. These parameters may be monitored and analysed to generate corresponding attribute values that reflect the current state and behaviour of the digital artifact. The processing circuitry may analyse parameter values such as cyclomatic complexity metrics, code coverage percentages, dependency counts, and security scan results to determine attribute values for the functional attributes, non-functional attributes, and hidden attributes.

For instance, a high cyclomatic complexity parameter value may result in an elevated attribute value for code maintainability, indicating that the digital artifact may require refactoring to improve readability and maintainability. The belief space creation process may involve mapping these parameter-derived attribute values to corresponding belief types, where each belief type represents a specific aspect of the operational status associated with the digital artifact. The attribute values may serve as input data for calculating probability scores and confidence scores associated with each belief state within the belief space. The probability scores and confidence scores may facilitate the maintenance of a comprehensive and dynamic understanding of the state of the digital artifact.

An occurrence of an internal or external event associated with a first digital artifact may alter parameters of the first digital artifact, which may be reflected by corresponding changes in a first belief space associated therewith. The event may affect a first subset of belief types of a first set of belief types associated with the first belief space, thereby altering a first subset of belief states of a first set of belief states associated with the first set of belief types. In an embodiment, the event associated with the first digital artifact may correspond to configuration changes, for example, modifications to parameters included within the first digital artifact. In some embodiments, the event associated with the first digital artifact may correspond to an update in a version of the first digital artifact, for example, installing patches, upgrades, or rolling back to earlier versions. In some embodiments, the event associated with the first digital artifact may correspond to performance changes of the first digital artifact, for example, variations in memory usage, CPU load, latency, throughput, or the like. For example, frequent modifications to the first digital artifact may lead to a change in the belief state of a performance hotspot belief type, indicating an increased likelihood of performance issues requiring optimization attention. In some embodiments, the event associated with the first digital artifact may correspond to the occurrence of an error or fault in the first digital artifact, for example, new exceptions, crashes, or recovery from prior faults. In some embodiments, the event associated with the first digital artifact may correspond to security changes, for example, detection of vulnerabilities, integrity issues, permission updates, or access violations. Similarly, a change in access control policies or exposure of previously protected interfaces may make the first digital artifact vulnerable, resulting in a change in the belief state of a security vulnerability belief type to reflect the increased security risk. In some embodiments, the event associated with the first digital artifact may correspond to dependency changes, for example, updates, removals, or failures in linked libraries, APIs, or services associated with the first digital artifact. Other events that may trigger belief state changes include, but are not limited to, code commits, bug reports, security incidents, or changes in developer interaction patterns.

Notably, the performance, availability, reliability, safety, integrity, or maintainability of the client computing system 104 may be dependent on the set of belief spaces associated with each digital artifact of the set of digital artifacts 110. Therefore, identifying and managing the set of belief spaces associated with each digital artifact of the set of digital artifacts 110 may be required for ensuring the dependability and effective operation of the client computing system 104. The identification and maintenance of the set of belief spaces may be facilitated by the belief space management system 102. Throughout the description, the phrases ‘the management of the belief spaces’ and ‘the management of belief states’ are used interchangeably. Throughout the description, the belief space management system 102 is interchangeably referred to as the system 102.

As shown, the belief space management system 102 may include processing circuitry 114 and a storage element 116. The processing circuitry 114 may be communicably associated with the storage element 116 directly (for example, via a communication bus) or via the communication network 108.

The processing circuitry 114 may include suitable logic, circuitry, interfaces, and/or code, that when executed, may execute one or more operations associated with the management of the belief spaces for the digital artifacts. The processing circuitry 114 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person skilled in the art that the processing circuitry 114 may be compatible with multiple operating systems. The processing circuitry 114 may further include one or more components (for example, a parser, a loader, or the like) that may be configured to execute one or more operations to be executed by the processing circuitry 114. In some embodiments, the processing circuitry 114 may be a single unit. Alternatively, in some embodiments, the processing circuitry 114 may be a combination of various modules configured to execute the one or more operations associated with the management of belief spaces associated with the set of digital artifacts 110 and 112.

The processing circuitry 114 may be associated with the storage element 116. The storage element 116 may refer to a hardware or software component configured to store the set of digital artifacts 110 and a set of belief spaces 118 associated with a set of digital artifacts (for example, the set of digital artifacts 110 or 112). For the sake of brevity, it is assumed that the storage element 116 has stored therein the set of belief spaces 118 associated with the set of digital artifacts 110. However, in other embodiments, the storage element 116 may further store a set of belief spaces associated with the set of digital artifacts 112. In some embodiments, the set of digital artifacts 110 may be stored in the storage element 116. In another embodiment, the set of digital artifacts 110 may be hosted on the client computing system 104, and accessed by the belief space management system 102 via the communication network 108. In an embodiment, prior to storing the set of belief spaces 118 in the storage element 116, the processing circuitry 114 may be further configured to create the set of belief spaces 118. For the creation of the set of belief spaces 118, the processing circuitry 114 may be configured to create a standard format file of the set of digital artifacts 110. In an embodiment, to create a first belief space 118a of the set of belief spaces 118, the processing circuitry 114 may be configured to create a standard format file for the first digital artifact of the set of digital artifacts 110. As used herein, the term standard format file may refer to an Abstract Syntax Tree (AST) representation that may correspond to a tree-based structural representation of a source code of the set of digital artifacts 110. The standard format file may represent the logical structures associated with the set of digital artifacts 110 in the form of nodes, where each node corresponds to a programming construct such as functions, classes, methods, conditional statements, loops, expressions, variable declarations, or other syntactic elements. The standard format file may capture the hierarchical relationships and dependencies between different code components in the set of digital artifacts 110, providing a unified and language-independent structure that enables systematic parsing, analysis, and transformation of the set of digital artifacts 110. In some embodiments, the standard format file may include associations among the one or more digital artifacts of the set of digital artifacts 110.

The standard format file may be generated using parsing tools and may support multiple programming languages to ensure compatibility across different codebases, thereby enabling structured syntax analysis regardless of the underlying programming language used to implement the set of digital artifacts 110. The standard format file may capture the hierarchical relationships and dependencies between different code components, providing a unified and language-independent structure that enables systematic parsing, analysis, and transformation of the digital artifact. In an example, the standard format file may be based on a programming language associated with the first digital artifact. The standard format file may be created based on the syntax and semantics associated with the programming language of the first digital artifact. The standard format file may be generated using parsing tools and may support multiple programming languages to ensure compatibility across different codebases, thereby enabling structured syntax analysis regardless of the underlying programming language used to implement the digital artifact.

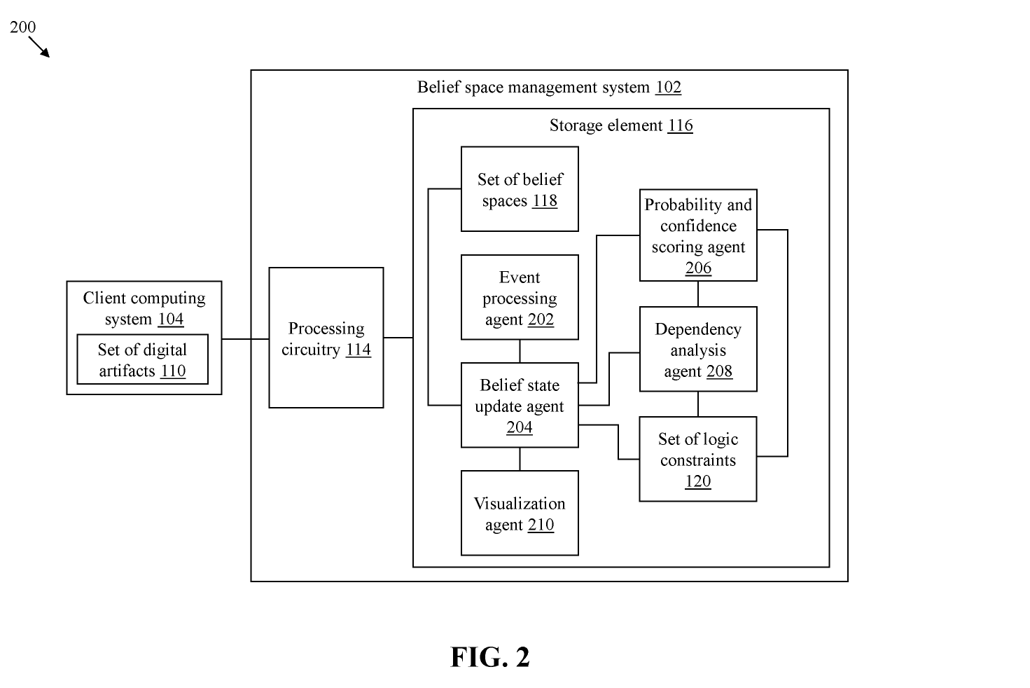

The first digital artifact may be associated with a first plurality of parameters (for example, edit time, edit source, security pattern, version, or the like) that may be indicative of a plurality of attribute values for a plurality of attributes associated with the first digital artifact. The plurality of attributes may include a plurality of functional attributes, a plurality of non-functional attributes, or a plurality of hidden attributes. The first plurality of parameter values may be determined by the processing circuitry 114 based on monitoring of the set of digital artifacts 110 and tracking one or more changes, events, or the like associated therewith. In some embodiments, such tracking may be performed by one or more agents of a set of agents of the belief space management system 102, which are described in conjunction with FIG. 2.

The processing circuitry 114 may be further configured to determine a first plurality of attribute values for a first plurality of attributes based on the first plurality of parameter values. In an example, the processing circuitry 114 may determine the first plurality of attribute values for the plurality of functional attributes associated with the first digital artifact. In another example, the processing circuitry 114 may determine the first plurality of attribute values for the plurality of non-functional attributes associated with the first digital artifact. In yet another example, the processing circuitry 114 may determine the first plurality of attribute values for the plurality of hidden attributes associated with the first digital artifact. In some other examples, the processing circuitry 114 may determine the first plurality of attribute values for a combination of the plurality of functional attributes, the plurality of non-functional attributes, or the plurality of hidden attributes associated with the first digital artifact.

In an embodiment, the first plurality of attribute values for the plurality of functional attributes may include attribute values associated with function calls and dependencies. For instance, the first digital artifact may correspond to a ticket booking service. In such an instance, examples of function calls may include search flight, book ticket, cancel ticket, or the like. Similarly, examples of dependencies may include flightDatabase.queryFlights, pricingEngine.calculateFare, or the like. These dependencies may represent external functions, databases, APIs, or services that the first digital artifact may interact with for facilitating the functionality associated therewith.

In some embodiments, the first plurality of attribute values for the plurality of functional attributes may include attribute values for external libraries and versions associated with the first digital artifact, such as a request having version 2.31.0, pydantic having version 2.3.0, or the like. In some embodiments, the first plurality of attribute values for the plurality of functional attributes may include attribute values for test coverage. For example, for the first digital artifact corresponding to the ticket booking service, attribute values associated with the test coverage may include total functions: 15, covered functions: 12, coverage percentage: 80, line coverage: 82%, branch coverage: 68%, integration tests: true, load tests: partial, or the like.

In some embodiments, the first plurality of attribute values for the plurality of non-functional attributes may include attribute values associated with static analysis metrics. For example, cyclomatic complexity: 22, quality risk: high. In some embodiments, the first plurality of attribute values for the plurality of non-functional attributes may include attribute values for code smells: [“long method”, “duplicate code”], maintainability index: 48, or the like. In some embodiments, the first plurality of attribute values for the plurality of non-functional attributes may include attribute values associated with a performance hotspot. For example, the search flight function may be identified as a performance hotspot due to factors such as an average response time of around 2.9 seconds per request, which may result in high latency for users associated with the client computing system 104, a memory usage of approximately 900 megabytes (MB) during execution, that may indicate excessive resource consumption and potential scalability issues under heavy load, or the like. In some embodiments, the first plurality of attribute values for the plurality of non-functional attributes may include attribute values associated with deprecated APIs: sendEmailLegacy(), smsGatewayV1(), risk level: medium, or the like. In some embodiments, the first plurality of attribute values for the plurality of non-functional attributes may include attribute values associated with security vulnerabilities, such as id: CWE-89, type: SQL Injection, severity: critical, id: CWE-352, type: CSRF, severity: medium.

In some embodiments, the first plurality of attribute values for the plurality of hidden attributes may include attribute values associated with edit frequency. For example, 47 edits within a two-week iteration cycle. In some embodiments, the first plurality of attribute values for the plurality of hidden attributes may include attribute values for navigation depth. For example, an average of 12 file jumps per session indicates cross-digital artifacts dependencies. In some embodiments, the first plurality of attribute values for the plurality of hidden attributes may include attribute values associated with co-edit frequency. For example, co-edit frequency: high (shared edits with 3 other developers in over 65% of commits). In some embodiments, the first plurality of attribute values for the plurality of hidden attributes may include attribute values associated with review churn rate. For example, review churn rate: 28% of submitted changes reverted or refactored within two subsequent commits. In some embodiments, the first plurality of attribute values for the plurality of hidden attributes may include attribute values associated with idle interaction time. For example, idle interaction time: an average of 18 minutes between consecutive edits, which may reflect context-switching overhead. The plurality of hidden attributes may further capture implicit developer behaviour, such as repetitive navigation patterns across the set of digital artifacts 110, frequent toggling between test and implementation digital artifacts of the set of digital artifacts 110, or the like, indicating potential cognitive load, collaboration bottlenecks, or maintainability challenges associated with the first digital artifact.

The processing circuitry 114 may be further configured to generate, for the first digital artifact, a structured file format based on at least one of the standard format file and the first plurality of attribute values. As used herein, the term structured file format may correspond to JavaScript object notation (JSON), Extensible Markup Language (XML), or the like.

In an embodiment, the processing circuitry 114 may utilize a large language model (LLM) for the generation of the structured file format. In such an embodiment, the processing circuitry 114 may provide the LLM with a detailed prompt. For example, the prompt may correspond to:

“You are an expert code documentation assistant. Your task is to generate comprehensive and accurate docstrings for code functions based on their AST representation. Follow these guidelines: Analyze the provided AST carefully, focusing on function signatures, parameters, return types, and the overall structure of the code. Generate a clear and concise description of the function’s purpose and functionality. List and describe all parameters, including their types and purpose. Specify the return value and its type. Mention any side effects or important behaviours of the function. If applicable, provide a brief usage example. Use the appropriate docstring format for the programming language (e.g., PEP 257 for Python, JSDoc for JavaScript). Avoid redundant information or restarting the obvious. If the function uses any complex algorithm or designation patterns, briefly mention them. Flag any potential issues, such as deprecated API usage or performance concerns. Remember to maintain a professional tone and prioritize clarity and accuracy in your documentation. Your goal is to help developers understand and use the function effectively.”

In an embodiment, for detailed generation of the structured file format associated with the first digital artifact, the prompt may further include programming language-specific conventions associated with the programming language of the first digital artifact.

The processing circuitry 114 may be further configured to create the first belief space 118a based on the generated structured file format. In an embodiment, the processing circuitry 114 may utilize various tools, such as ANother tool for language recognition (ANTLR), Babel, Tree-sitter, Roslyn, or the like, for creation of the first belief space 118a for the first digital artifact. The creation of the first belief space 118a may enable analysis of the first digital artifact associated with the legacy software package. The processing circuitry 114 may be further configured to store the first belief space 118a in the storage element 116.

The processing circuitry 114 may be configured to create and store remaining belief spaces of the set of belief spaces 118 in a manner similar to the creation and storing of the first belief space 118a. Notably, a corresponding belief space may be created for each digital artifact of the set of digital artifacts 110. As shown, the first belief space 118a is created for the first digital artifact, whereas a second belief space 118b is created for a second digital artifact of the set of digital artifacts 110.

The storage element 116 is further shown to include a set of logic constraints 120. The set of logic constraints 120 may correspond to a repository of rules, algorithms, and weightings that may facilitate adjusting a set of belief states associated with a set of belief types in the belief space for each digital artifact of the set of digital artifacts 110. The set of logic constraints 120 may contain rules, weights, priority, dependency, or the like for impact assessment of the event on the set of belief types associated with each digital artifact of the set of digital artifacts 110.

For example, if two developers (e.g., developer A and developer B) are attempting to modify a first method included within the first digital artifact within a very short time window. Developer A may rename the first method to improve readability, while developer B may introduce new parameters to the first method in order to extend the functionalities associated with the first method. These edits may create a direct conflict because renaming the first digital artifact may change the identifier of the first method, whereas introducing new parameters may modify the signature associated with the first method. Such a scenario may demonstrate that the two modifications may not be applied together without reconciliation. To handle such a scenario, the processing circuitry 114 may access the set of logic constraints 120 and apply a conflict-resolution rule stored therein. For example, the conflict-resolution rule may indicate that the first edit (e.g., the rename) is committed, whereas the second edit (e.g., the parameter addition) is placed in a queue for later reconciliation.

In some embodiments, the set of logic constraints 120 may store a developer risk-aware rule indicative of analysing a risk profile of a developer for resolving a conflict. The risk profile may reflect the reliability of the developer based on the past contributions of the developer. The risk profile of the developer may be generated based on the plurality of hidden attributes. For example, if the developer interactions indicate that the code edits performed by the developer often lead to rollbacks, bug fixes, or repeated code reviews, the risk profile of the developer may be classified as high. In such a scenario, to resolve the conflict, the processing circuitry 114 may use the risk profile of both developers A and B. For example, based on the risk profiles, the processing circuitry 114 may prioritize the edits performed by a low-risk developer (for example, developer A) and defer the edits performed by a high-risk developer.

Notably, the plurality of hidden attributes, such as patterns that may reflect how developers work, decision-making tendencies of the developers, or the like, may enable the processing circuitry 114 to prioritize the edits based on the risk profile of the developer. Further, the plurality of hidden attributes may reduce the likelihood of introducing unstable or low-quality code into the software package.

In an embodiment, the processing circuitry 114 may further generate a notification such that both the developers A and B are made aware of the conflict and may perform a collaborative review. In this way, the conflict may be resolved according to the rules stored in the set of logic constraints 120, thereby preserving consistency in the historical data associated with the first digital artifact and avoiding overwriting the first digital artifact or data loss associated therewith.

In operation, the processing circuitry 114 may monitor the first plurality of attribute values for the first plurality of attributes associated with the first digital artifact. For the sake of ongoing discussion, the first plurality of attribute values may correspond to a current attribute values associated with the plurality of functional attributes at a first time instance. For example, a searchFlights function may be associated with the first digital artifact. The searchFlights function may be responsible for retrieving available flight options for users associated with the client computing system 104. The searchFlights function may usually respond in about 1.2 seconds per request. The processing circuitry 114 may monitor that the average response time has increased to 2.9 seconds.

The increase in the average response time may indicate that the searchFlights function has crossed the acceptable performance threshold (for example, 2 seconds). Based on a change in parameter value of a parameter average response time, an attribute value of an attribute ‘performance criterion’ of the first plurality of attributes may have transitioned from ‘Optimal’ to ‘Suboptimal’. Therefore, the processing circuitry 114 may determine, based on the monitoring, a transition of the first plurality of attribute values to a second plurality of attribute values. The transition may have happened at a second time instance with the second time instance occurring after the first time instance. Notably, the second plurality of attribute values may be indicative of first operational metadata for a set of operations associated with the event. For example, the first operational metadata may include information associated with a last commit author who has made changes to the first digital artifact, a commit message and changes (e.g., added filtering by baggage allowance on September 15, 2025), update frequency associated with the first digital artifact, whether the increased response time is caused by reliance on outdated APIs (e.g., old flight data providers), indicative of the risk of using deprecated APIs, whether the increased response time has exposed hidden vulnerabilities, such as susceptibility to denial-of-service (DoS) attacks, whether inefficient coding practices (e.g., nested loops, redundant data fetching) are associated with the first digital artifact, whether load or stress test (e.g., test coverage) is performed for testing the first digital artifact, or the like.

The processing circuitry 114 may be further configured to access, based on the detection of the event, the first belief space 118a associated with the first digital artifact. The processing circuitry 114 may be further configured to identify from the first belief space 118a, a first subset of belief types associated with the first belief space. Notably, the processing circuitry 114 may be configured to identify the first subset of belief types based on the first operational metadata. In an embodiment, the processing circuitry 114 may utilise a classification algorithm for identifying the first subset of belief types. As described above, each belief type of the first subset of belief types may correspond to an attribute of the first digital artifact that is being impacted by the occurrence of the event. For example, the processing circuitry 114 may identify, based on the first operational metadata, the first subset of belief types including performance, security and vulnerability, test coverage, and deprecated API, with a first belief type corresponding to performance, a second belief type corresponding to security and vulnerability, a third belief type corresponding to test coverage, and a fourth belief type corresponding to deprecated API. Further, the processing circuitry 114 may be configured to determine a first subset of belief states, associated with the first subset of belief types, that is to be updated based on the event.

In an embodiment, initial belief state associated with each belief type of the set of belief types may be populated, by the processing circuitry 114, through static analysis, code parsing, and historical data processing from sources such as, but not limiting to, source code, documentation, production tickets, security logs, and developer activities associated one or more digital artifacts of the set of digital artifacts 110.

For example, prior to the occurrence of the event, a first belief state associated with the first belief type may correspond to a current state of the first belief type. The current state may indicate the most up-to-date understanding of the functional situation of the first belief type. In other words, the current state of the first belief type may include all the information associated with the first belief type that has been determined up to the second time instance. Further, the current state of the first belief type may be maintained as an active state until an update is triggered by the event (for example, the event response time exceeding the threshold). For example, the first belief state of the first belief type that corresponds to the performance attribute may indicate that the performance of the first digital artifact in the correct recommendation of flights is high. For example, the first digital artifact may recommend correct flights 97% of the time. Further, the occurrence of the event may trigger a simultaneous transition of the first belief state from the current state at the first time instance to a new state at the second time instance, whereas the first belief state at the first time instance may correspond to a previous state of the first belief type relative to the second time instance. That is to say, the first belief state may correspond to the previous state of the first belief type of the first subset of belief types. Notably, upon the transition, the new belief state of the first belief type at the second time instance may correspond to a current state of the first belief type.

Notably, the transition of the first belief state to the new state, that represents the current state, may be indicative of an update of the first belief state based on the event. The update of the first belief state may reflect the incorporation of recent observations or changes associated with the first digital artifact. For example, as the searchFlights function takes a higher time to generate recommendations, the searchFlights function may miss time-sensitive opportunities, such as the best available flights or fares, leading to less optimal suggestions. Additionally, such delays may cause the searchFlights function to process outdated information, resulting in recommendations that may no longer match the current flight availability. As a result, the performance of the first digital artifact in the correct recommendation of flights may decrease. That is to say, the updated first belief state of the first belief type may indicate that the performance of the first digital artifact in the correct recommendation of flights is low. For instance, the first digital artifact may now recommend correct flights 88% of the time.

In an embodiment, prior to updating the first belief state associated with the first belief type, the processing circuitry 114 may be further configured to determine, based on the second plurality of attribute values, a probability score associated with a current state of the first belief type or a confidence score associated with the corresponding probability score.

As used herein, the term probability score may refer to a numerical value that quantifies the likelihood or probability that a particular belief state associated with a belief type is true or accurate at a given point in time. As used herein, the term confidence score may refer to a numerical measure that indicates the reliability, certainty, or trustworthiness of the calculated probability score. In some embodiments, the processing circuitry 114 may utilize conditional probability calculations to determine the probability score. In some embodiments, the processing circuitry 114 may utilize algorithms such as bootstrap sampling methods, cross-validation techniques, ensemble methods, or the like for the determination of the confidence score.

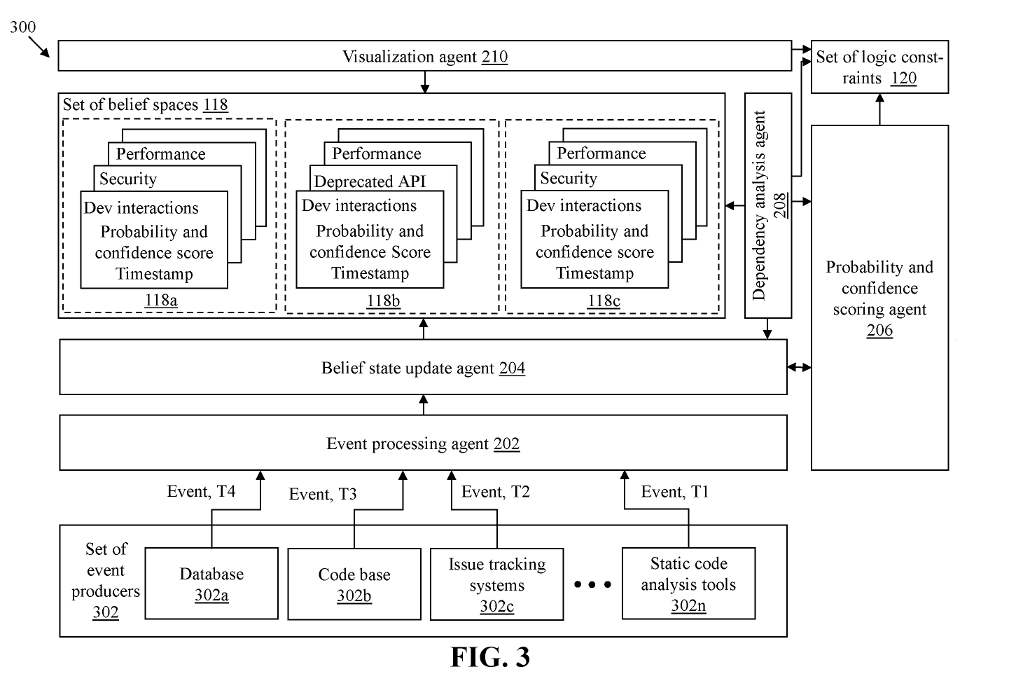

In an embodiment, the processing circuitry 114 may be configured to determine the probability score and the confidence score based on the set of logic constraints 120. The determination of the probability score and the confidence score is explained in detail in conjunction with FIG. 3.

The processing circuitry 114 may be further configured to determine whether the probability score associated with the first belief state falls below a threshold probability score. In an embodiment, the threshold probability score may be indicative of whether a belief state (for example, the first belief state of the first belief type) is required to be updated due to the event. For example, the processing circuitry 114 may determine that the probability score of a first belief state of the first subset of belief states being true is 60%, with a confidence score of 80%. The processing circuitry 114 may further determine the threshold probability score. In an example, the threshold probability score for the first belief state may be 75%. As the probability score falls below the threshold probability score, the processing circuitry 114 may update the first belief state to reflect the changed conditions of the digital artifact. In an embodiment, if the probability score is greater than or equal to the threshold probability score, the processing circuitry 114 may not update the first belief state of the first belief type. Notably, each belief state of the first subset of belief states may be updated in a manner similar to as described for the first belief state. That is to say, the processing circuitry 114 is configured to update, based on the second plurality of attribute values, the first subset of belief states. Notably, in some embodiments, the first subset of belief states may be updated further based on the set of logic constraints 120.

In an example, a developer A may be running performance tests associated with the first digital artifact. Further, the processing circuitry 114 may monitor that the average response time of the first digital artifact has increased from 2.1 seconds to 2.9 seconds. At the same time, the developer A may repeatedly navigate between the implementation file of the first digital artifact and the associated unit test file. Although running the performance tests and navigating between the said files are independent activities, they may share a commonality in that both activities are linked to the testing process of the first digital artifact. The performance degradation of the first digital artifact may directly impact the belief type latency and the belief type scalability of the first digital artifact.

The belief type latency may refer to the delay associated with the execution of the one or more operations associated with the first digital artifact. For example, the increase in the average response time from 2.1 seconds to 2.9 seconds may indicate a degradation in the performance of the first digital artifact. The belief type scalability may be indicative of an ability of the first digital artifact to maintain acceptable performance levels as the workload increases. A change in the latency may therefore influence the scalability of the first digital artifact, for example, by reducing the number of requests or transactions the first digital artifact may process within a given time frame. Further, the navigation pattern of the developer A may reveal the belief type interaction behaviour of developer A. The interaction behaviour may refer to a pattern of developer activities associated with the software package, such as navigation between the implementation and test files, execution of test cases, or code editing operations.

In such a scenario, a belief state associated with a corresponding belief type, such as the latency, the scalability, and the interaction behaviour, may be updated simultaneously. For example, with an increase in response time, the belief state of the belief type latency may be updated from “normal” to “degraded” state. Similarly, with the first digital artifact’s throughput being decreased, the belief state of the belief type scalability may be updated from “stable” to “reduced performance”, to reflect reduced performance capacity. Simultaneously, repetitive navigation pattern of developer A may update the belief state of the belief type interaction behaviour, from “normal” to “high cognitive load”, to indicate higher cognitive load or debugging difficulty.

FIG. 2 is a block diagram 200 that illustrates the belief space management system 102, consistent with disclosed embodiments of the present disclosure. For the sake of brevity, FIG. 2 is explained in conjunction with elements from FIG. 1. Referring to FIG. 2, the belief space management system 102 is shown to include the processing circuitry 114 that is coupled to the storage element 116 as described in conjunction with FIG. 1.

As mentioned previously, the storage element 116 is configured to store the set of belief spaces 118 and the set of logic constraints 120. The storage element 116 is further configured to store a set of agents, including an event processing agent 202, a belief state update agent 204, a probability and confidence scoring agent 206, a dependency analysis agent 208, and a visualization agent 210. The processing circuitry 114 may be further configured to access the storage element 116 directly or via the communication network 108 to coordinate various operations executed by each agent of the set of agents. In some embodiments, the set of agents may include additional or different agents that may be configured to execute one or more operations associated with the management of the belief space for the digital artifacts.

The set of agents stored in the storage element 116 may refer to a collection of autonomous or semi-autonomous computational entities, each configured to perform specific tasks or subtasks for the execution of the one or more operations associated with the management of belief spaces for the digital artifacts. The set of agents may include generative artificial intelligence (AI)-based agents and agentic AI-based agents. The generative AI-based agents may utilize generative models (such as large language models or diffusion models) to create content, generate responses, or synthesize data based on learned patterns whereas the agentic AI-based agents may be capable of goal-directed behaviour, operate with a degree of autonomy, and may interact with other agents or components to plan, execute, and adapt actions in pursuit of defined objectives and goals, while exhibiting traits such as reasoning, decision-making, and feedback incorporation. Each agent in the set of agents may operate independently or collaboratively with one or more other agents of the set of agents. In some embodiments, the operations executed by each agent may be coordinated by the processing circuitry 114.

The event processing agent 202 may be configured to monitor events associated with each digital artifact of the set of digital artifacts 110. In an embodiment, the processing circuitry 114 may utilize the event processing agent 202 to monitor the events associated with each digital artifact of the set of digital artifacts 110. In an embodiment, the event processing agent 202 may correspond to an AI-based system that employs artificial intelligence algorithms to monitor, capture, and categorize various events associated with each digital artifact of the set of digital artifacts 110. More specifically, the event processing agent 202 may be implemented as an agentic AI-based system, operating autonomously to detect events such as code commits, bug reports, security incidents, system updates, and user activity changes without requiring manual intervention. The agentic AI-based event processing agent 202 may possess goal-directed behaviour focused on real-time event detection to enable real-time updates associated with the overall performance of the client computing system 104, thereby aiding in rapid response to issues, reducing manual overhead, and accelerating remediation cycles. The real-time update and rapid responses to issues may further aid in computational efficiency and reliability of the client computing system 104.

The belief state update agent 204 may be configured to update a set of belief states associated with a set of belief types for each digital artifact of the set of digital artifacts 110, in response to the events. In an embodiment, the processing circuitry 114 may utilize the belief state update agent 204 that is an AI-based system employing artificial intelligence algorithms to update the set of belief states associated with the set of belief types for each digital artifact of the set of digital artifacts 110, in response to the events. More specifically, the belief state update agent 204 is implemented as an agentic AI-based system that operates autonomously to update the set of belief states based on new evidence, events, and user interactions. The agentic AI-based belief state update agent 204 possesses goal-directed behaviour focused on maintaining accurate and current belief representations, decision-making capabilities to determine which belief state of the set of belief states (for example, the first subset of belief states of the first set of belief states) require an update based on incoming information, and adaptive learning mechanisms to refine an accuracy of each belief state of the set of belief states over time through continuous evidence integration.

The probability and confidence scoring agent 206 may be configured to calculate and update probability and confidence scores for each belief state of the set of belief states associated with each belief type of the set of belief types (for example, the first belief state of the first belief type associated with the first digital artifact) using advanced probabilistic modelling (e.g., Markov models, Monte Carlo simulations, Bayesian inference). In an embodiment, the processing circuitry 114 may utilize the probability and confidence scoring agent 206, that is an AI-based system employing artificial intelligence algorithms to calculate and update the probability and confidence scores for each belief state of the set of belief states. More specifically, the probability and confidence scoring agent 206 is implemented as an agentic AI-based system that operates autonomously to evaluate the likelihood and reliability of each belief state of the set of belief states. The agentic AI-based probability and confidence scoring agent 206 possesses goal-directed behaviour focused on providing accurate quantitative assessments of uncertainty and reliability, decision-making capabilities to determine appropriate scoring methodologies based on available evidence and historical data. Further, the probability and confidence scoring agent 206 may enable sophisticated scoring that may enable the processing circuitry 114 to prioritize operations associated with the highest expected impact, optimizing resource usage and reducing wasted computation on low-impact areas.

The dependency analysis agent 208 may be configured to create, maintain, and analyse a comprehensive dependency graph associated with the set of digital artifacts 110, identifying direct and indirect impacts of one or more events associated with the set of digital artifacts 110.

The dependency analysis agent 208 determines dependency relationships between two or more digital artifacts of the set of digital artifacts 110 based on the dependency graphs. In an embodiment, dependency relationships may correspond to semantic associations or syntactic associations between the two or more digital artifacts of the set of digital artifacts 110. In an embodiment, the processing circuitry 114 may utilize the dependency analysis agent 208 for identifying, based on the occurrence of the one or more events, the two or more digital artifacts of the set of digital artifacts 110 that are syntactically or semantically associated with each other. The dependency analysis agent 208 is an AI-based system that employs artificial intelligence algorithms to analyse, map, and maintain complex interdependencies between the two or more digital artifacts of the set of digital artifacts 110.

More specifically, the dependency analysis agent 208 is implemented as an agentic AI-based system that operates autonomously to discover both direct and indirect relationships between the two or more digital artifacts of the set of digital artifacts 110. The agentic AI-based dependency analysis agent 208 possesses goal-directed behaviour focused on maintaining comprehensive and accurate dependency mappings, decision-making capabilities to determine the significance and type of dependency relationships (for example, the semantic or syntactic associations) between the two or more digital artifacts of the set of digital artifacts 110, and adaptive learning mechanisms to continuously refine dependency detection accuracy through analysis of usage behaviour pattern associated with the two or more digital artifacts and user interactions. The mapping and updating of the dependencies may ensure that optimization performed in one digital artifact may be propagated efficiently through the remaining digital artifacts of the set of digital artifacts 110, thereby preventing redundant computations and aiding in efficient memory utilization. The mapping and updating the dependencies may further lead to faster data retrieval, optimized execution paths, and lower computational overhead.

In an embodiment, the dependency analysis agent 208 may be further configured to create the dependency graph based on the set of belief spaces 118. In an embodiment, the dependency analysis agent 208 may be configured to create the dependency graph based on the rules and associations described in the set of logic constraints 120 for one or more belief spaces of the set of belief spaces 118.

The dependency graph may be created based on a syntactic association between each belief space of the set of belief spaces 118 or a semantic association between each belief space of the set of belief spaces 118. For example, in case of the syntactic association, the first belief space 118a may be associated with the second belief space 118b based on an encoded linkage between the first digital artifact and the second digital artifact. In another example, the first belief space 118a may be associated with the second belief space 118b based on the first digital artifact importing the second digital artifact via an import statement. In another example, the first belief space 118a may be associated with the second belief space 118b based on a class of the first digital artifact implementing or extending an interface from the second digital artifact. In another example, the first belief space 118a may be associated with the second belief space 118b based on the second digital artifact being organized hierarchically within the legacy software package. In yet another example, the first belief space 118a may be associated with the second belief space 118b based on the first digital artifact invoking a function or method defined in the second digital artifact.

In case of the semantic association, the first belief space 118a may be associated with the second belief space 118b based on the functional dependencies or operational behaviour of the first digital artifact and the second digital artifact. For example, the first digital artifact and the second digital artifact may both interact with a common database associated with the client computing system 104. Notably, any change in the structure, schema, or behaviour of the database may directly impact the first digital artifact and the second digital artifact, as the correctness and functionality of the first digital artifact and the second digital artifact may be dependent on the shared data. That is to say, even if the first digital artifact and the second digital artifact are not syntactically associated with each other, the semantic association may capture dependencies between the first digital artifact and the second digital artifact.

Although the examples are explained in terms of the first digital artifact or the second digital artifact, the scope of the present disclosure is not limited to it. The syntactic or semantic associations may exist between any number of digital artifacts included within the legacy software package. That is to say, each digital artifact may be syntactically or semantically connected to one or more digital artifacts of the set of digital artifacts 110.

The visualization agent 210 may be configured to dynamically present, via user devices, to users (for example, one or more stakeholders) associated with the client computing system 104, prioritized, context-aware visualizations of a current set of belief states for a set of belief types associated with each digital artifact of the set of digital artifacts 110. In an embodiment, the processing circuitry 114 may utilize the visualization agent 210 that is an AI-based system employing artificial intelligence algorithms to generate, customize, and dynamically adjust visual representations of the current set of belief states for the set of belief types associated with each digital artifact of the set of digital artifacts 110.

The processing circuitry 114 may be further configured to store the set of agents in the storage element 116. The processing circuitry 114 may be further configured to access the set of agents from the storage element 116. Operations executed by the event processing agent 202, the belief state update agent 204, the probability and confidence scoring agent 206, the dependency analysis agent 208, and the visualization agent 210 may actually be executed by the processing circuitry 114 that utilizes the event processing agent 202, the belief state update agent 204, the probability and confidence scoring agent 206, the dependency analysis agent 208, and the visualization agent 210.

FIG. 3 is a schematic diagram 300 that illustrates a process flow for an exemplary implementation of the belief space management system 102, consistent with disclosed embodiments of the present disclosure.

Referring to FIG. 3, the schematic diagram 300 is illustrated, which includes a set of event producers 302a-302n. The event producers 302a-302nmay include, for example, a database 302a, a code base 302b, an issue tracking system 302c, and other event producers up to an nth event producer 302, such as a static code analysis tool. The set of event producers 302a-302n may correspond to a service or a component of the client computing system 104 that may cause an occurrence of the event associated with the first digital artifact.

For example, insertion or deletion of a row or a column in the database 302a, the database 302a may cause an occurrence of a first event. Similarly, a code committed in the code base 302b may cause an occurrence of a second event. Similarly, creation of a high-priority production ticket or assignment of a critical bug report in the issue tracking system 302c may cause an occurrence of a third event. Similarly, detection of security vulnerabilities, code smells, or performance issues during automated scanning by the static code analysis tool 302n may cause an occurrence of a fourth event.

In an embodiment, the event processing agent 202 may detect an event associated with the issue tracking system 302c. For example, the event processing agent 202 may detect that a high risk production ticket is being raised by the issue tracking system 302c. The high risk production ticket may be indicative of the response time exceeding the threshold event as described in conjunction with FIG. 1. In such an embodiment, the event processing agent 202 may monitor the first plurality of attribute values for the first plurality of attributes associated with the first digital artifact. The event processing agent 202 may further determine, based on the monitoring, the transition of the first plurality of attribute values to the second plurality of attribute values. Based on the transition, the event processing agent 202 may detect the event associated with the first digital artifact. The event processing agent 202 may be further configured to communicate the second plurality of attribute values to the belief state update agent 204.

The belief state update agent 204 may be further configured to receive the second plurality of attribute values for the first plurality of attributes from the event processing agent 202. The belief state update agent 204 may be further configured to determine the first operational metadata based on the second plurality of attribute values. The belief state update agent 204 may be further configured to access the first belief space 118a associated with the first digital artifact. The belief state update agent 204 may be further configured to identify, from the first belief space 118a, the first subset of belief types. In an embodiment, the identification of the first subset of belief types may happen in a manner similar to as described in conjunction with FIG. 1. The belief state update agent 204 may be further configured to communicate the second plurality of attribute values to the probability and confidence scoring agent 206. In an embodiment, the belief state update agent 204 may communicate an instruction to the probability and confidence scoring agent 206, indicative of a requirement for an update in the first belief space 118a of the first digital artifact.

The probability and confidence scoring agent 206 may be further configured to, receive from the belief state update agent 204, the second plurality of attribute values for the first plurality of attributes. The probability and confidence scoring agent 206 may be further configured to determine, based on the second plurality of attribute values, the probability score associated with the current state of each belief type of the first subset of belief types and the confidence score associated with the corresponding probability score. In an embodiment, the probability and confidence scoring agent 206 may determine the probability score and the confidence score based on the set of logic constraints 120. The probability and confidence scoring agent 206 may be further configured to communicate the determined probability score and the confidence score associated with the current state of each belief type of the first subset of belief types to the belief state update agent 204.

The belief state update agent 204 may be further configured to receive from the probability and confidence scoring agent 206, the probability score associated with the current state of each belief type of the first subset of belief types and the confidence score associated with the corresponding probability score. The belief state update agent 204 may be further configured to update each belief state of the first subset of belief states, associated with each belief type of the first subset of belief types, based on the corresponding probability score and confidence score.

In an embodiment, the dependency analysis agent 208, by utilizing the set of logic constraints 120 and the dependency graph of the set of digital artifacts 110, may be further configured to determine that the first digital artifact is further associated with a second digital artifact. The dependency analysis agent 208 may further determine that the event is indirectly associated with the second digital artifact of the set of digital artifacts 110. That is to say, the dependency analysis agent 208 may further determine that the event is associated with the second digital artifact. In other words, the dependency analysis agent 208 is further configured to identify the second digital artifact. In such a scenario, the dependency analysis agent 208 may determine that an existing state of the second digital artifact may have been impacted due to the event, and therefore the current state of the second digital artifact may be different than the existing state of the second digital artifact.

In such a scenario, the dependency analysis agent 208 may be further configured to communicate to the belief state update agent 204 that the current state of the second digital artifact may also be impacted due to the event. The belief state update agent 204 may be further configured to access, based on the detection of the event, a second belief space 118b associated with the second digital artifact. Further, a third plurality of attribute values for a second plurality of attributes associated with the second digital artifact may be determined in a manner similar to as described for the determination of the first plurality of attribute values. In such a scenario, the third plurality of attribute values may be determined by the belief state update agent 204. Notably, the third plurality of attribute values may be indicative of second operational metadata in a manner similar to the second plurality of attribute values being indicative of the first operational metadata. The belief state update agent 204 may be further configured to identify, from the second belief space 118b, a second subset of belief types associated with the second digital artifact. The second subset of belief types may be identified in a manner similar to as described for the identification of the first subset of belief types. As described for the first subset of belief types, the second subset of belief types is associated with a second subset of belief states that is to be updated based on the event. The belief state update agent 204 may be further configured to update, based on the third plurality of attribute values, the second subset of belief states associated with the second subset of belief types in a manner similar to as described for the first subset of belief states associated with the first subset of belief types.

In an embodiment, the dependency analysis agent 208 may be further configured to identify, based on the dependency graph, a third belief space 118c associated with a third digital artifact of the set of digital artifacts 110. The identification of the third belief space 118c, based on the dependency graph, may demonstrate that the dependency graph is indicative of the association (for example, the syntactic association or the semantic association) of the first belief space 118a with the third belief space 118c based on the first digital artifact being associated with the third digital artifact. Notably, the association of the third belief space 118c with the first belief space 118a is determined based on the dependency graph.

In such an embodiment, the dependency analysis agent 208 may be further configured to communicate the identified third belief space 118c to the belief state update agent 204. Further, the belief state update agent 204 may access the third belief space 118c associated with the third digital artifact. The belief state update agent 204 may determine a fourth plurality of attribute values for a third plurality of attributes associated with the third digital artifact in a manner similar to as described for the determination of the first plurality of attribute values for the first plurality of attributes. Notably, the fourth plurality of attribute values may be indicative of third operational metadata in a manner similar to the second plurality of attribute values being indicative of the first operational metadata. The belief state update agent 204 may be further configured to identify, from the third belief space 118c, a third subset of belief types associated with the third digital artifact. The third subset of belief types may be identified in a manner similar to as described for the identification of the first subset of belief types. As described for the first subset of belief types, the third subset of belief types is associated with a third subset of belief states that is to be updated based on the event. The belief state update agent 204 may be further configured to update, based on the fourth plurality of attribute values, the third subset of belief states associated with the third subset of belief types in a manner similar to as described for the first subset of belief states associated with the first subset of belief types.

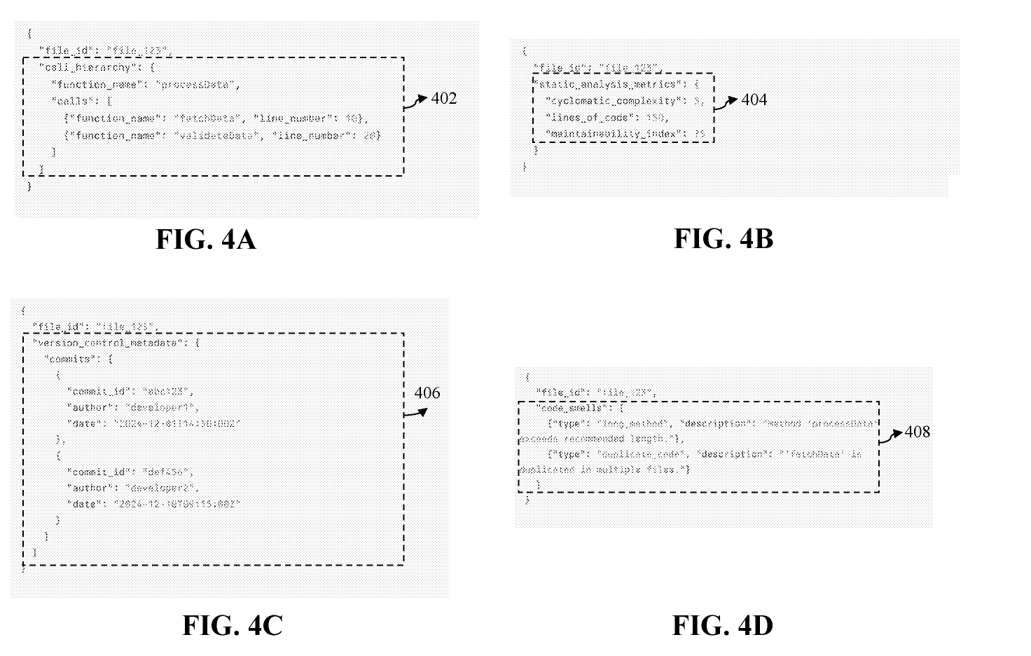

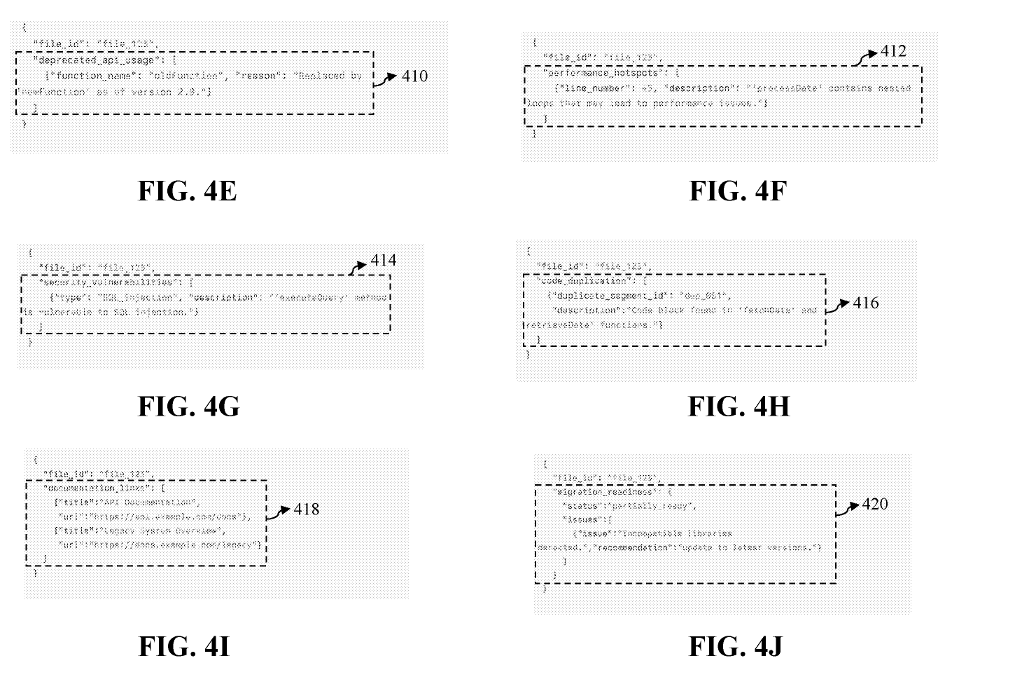

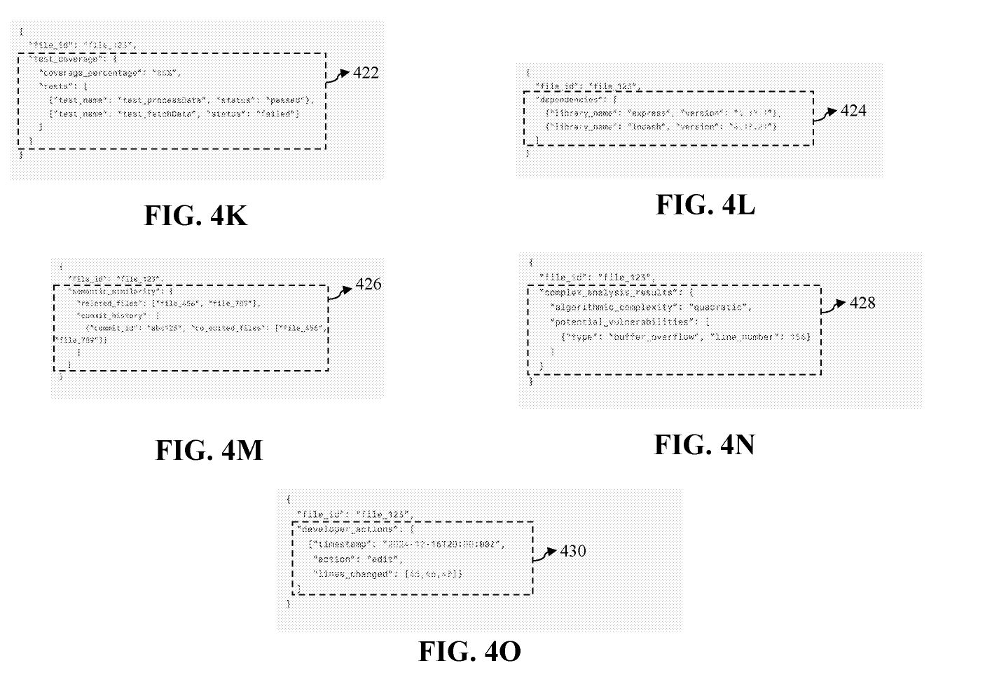

FIGS. 4A-4O, collectively, illustrate examples of the first plurality of attribute values included within the structured file format associated with the first digital artifact, consistent with disclosed embodiments of the present disclosure.

In an embodiment, the first digital artifact of the set of digital artifacts 110 may include a file_123. For the sake of brevity, the first plurality of attributes is illustrated in relation to the file_123, and should not be considered a limitation of the present disclosure.

Referring to FIG. 4A, shown is a dotted box 402 that includes a functional attribute call hierarchy associated with the first digital artifact.

Referring to FIG. 4B, shown is a dotted box 404 that includes a non-functional attribute static analysis metric associated with the first digital artifact.

Referring to FIG. 4C, shown is a dotted box 406 that includes hidden attributes version control metadata associated with the first digital artifact.

Referring to FIG. 4D, shown is a dotted box 408 that includes a non-functional attribute code smells associated with the first digital artifact.

Referring to FIG. 4E, shown is a dotted box 410, that includes a non-functional attribute, deprecated API usage associated with the first digital artifact.

Referring to FIG. 4F, shown is a dotted box 412, that includes a non-functional attribute performance hotspot associated with the first digital artifact.

Referring to FIG. 4G, shown is a dotted box 414, that includes a non-functional attribute security vulnerability associated with the first digital artifact.

Referring to FIG. 4H, shown is a dotted box 416, that includes a non-functional attribute code duplication associated with the first digital artifact.

Referring to FIG. 4I, shown is a dotted box 418, that includes a non-functional attribute documentation link associated with the first digital artifact. For example, the dotted box 418 illustrates the documentation links, such as API Documentation and Legacy system overview, along with the corresponding uniform resource locator (URL).

Referring to FIG. 4J, shown is a dotted box 420, that includes a non-functional attribute migration readiness status associated with the first digital artifact.

Referring to FIG. 4K, shown is a dotted box 422, that includes a functional attribute test coverage associated with the first digital artifact.

Referring to FIG. 4L, shown is a dotted box 424, that includes functional attribute dependency information. For example, the dotted box 424 illustrates external libraries that are associated with the file_123.

Referring to FIG. 4M, shown is a dotted box 426, that includes a functional attribute semantic similarity and a hidden attribute commit history associated with the first digital artifact. For example, the dotted box 426 illustrates that the file_123 is semantically associated with a file_456 and a file_789. Further, the dotted box 426 illustrates the commit history associated with the first digital artifact.

Referring to FIG. 4N, shown is a dotted box 428, that includes a functional attribute complex analysis result associated with the first digital artifact.

Referring to FIG. 4O, shown is a dotted box 430, that includes a hidden attribute developer action associated with the first digital artifact.

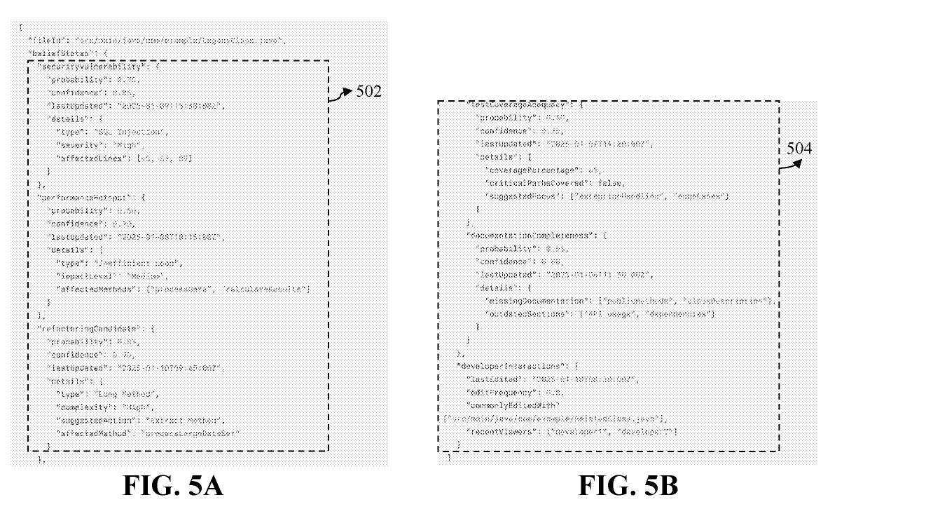

FIGS. 5A and 5B, collectively, illustrate examples of the first set of belief states associated with the first set of belief types, consistent with disclosed embodiments of the present disclosure.

Referring to FIG. 5A, shown is a dotted box 502, that includes some of the belief states associated with some of the belief types of the first set of belief types. For example, the dotted box 502 is shown to include belief states associated with the belief types, such as security vulnerability, performance hotspot, and refactoring candidate.

Referring to 5B, shown is a dotted box 504 that includes belief states associated with remaining belief types of the first set of belief types. For example, the dotted box 504 is shown to include belief states associated with the belief types, such as test coverage adequacy, documentation completeness, and developer interactions.

Notably, the examples illustrated in the dotted boxes 502 and 504 are illustrative and not exhaustive. The dotted boxes 502 and 504 may also include other belief states associated with the corresponding belief types of the first set of belief types.

It should be appreciated that the references to ‘first digital artifact’ and ‘second plurality of attribute values’, ‘first plurality of attributes’, ‘first operational metadata’, ‘first subset of belief types’, ‘first subset of belief states’, or other similar terms in the claims are not intended to refer to specific digital artifacts, plurality of attributes, operational metadata, subset of belief types, subset of belief states, respectively, but are used for distinguishing elements. A first element mentioned in the claims may correspond to a second element described in the specification, and vice versa. These may correspond to any of the digital artifacts associated with the set of digital artifacts 110 or 112.

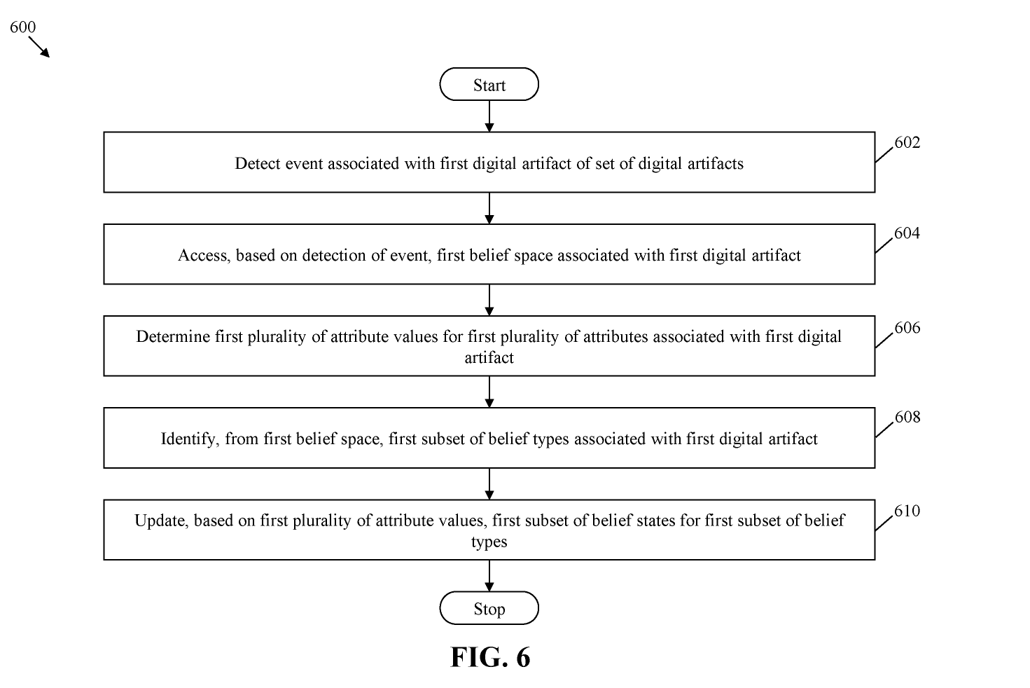

FIG. 6 represents a flowchart 600 that illustrates a method for updating the first subset of belief states for the first subset of belief types associated with the first digital artifact, consistent with disclosed embodiments of the present disclosure.

At 602, an event associated with the first digital artifact of the set of digital artifacts 110 may be detected. The processing circuitry 114 may detect the event associated with the first digital artifact of the set of digital artifacts 110. The processing circuitry 114 may utilize the event processing agent 202 to detect the event.

At 604, the first belief space 118a associated with the first digital artifact may be accessed based on the detection of the event. The processing circuitry 114 may access the first belief space 118a. The processing circuitry 114 may utilize the belief state update agent 204 to access the first belief space 118a.

At 606, the first plurality of attribute values for the first plurality of attributes associated with the first digital artifact may be determined. The processing circuitry 114 may determine the first plurality of attribute values for the first plurality of attributes associated with the first digital artifact. The processing circuitry 114 may utilize the event processing agent 202 for determining the first plurality of attribute values. The first plurality of attribute values may be indicative of first operational metadata for the set of operations associated with the event.

At 608, the first subset of belief types associated with the first digital artifact may be identified. The processing circuitry 114 may identify, from the first belief space 118a, the first subset of belief types associated with the first digital artifact. The processing circuitry 114 may utilize the belief state update agent 204 to identify the first subset of belief types associated with the first digital artifact.

At 610, the first subset of belief states for the first subset of belief types may be updated based on the first plurality of attribute values. The processing circuitry 114 may update the first subset of belief states for the first subset of belief types based on the first plurality of attribute values. The processing circuitry 114 may utilize the belief state update agent 204 to update the first subset of belief states for the first subset of belief types based on the first plurality of attribute values.

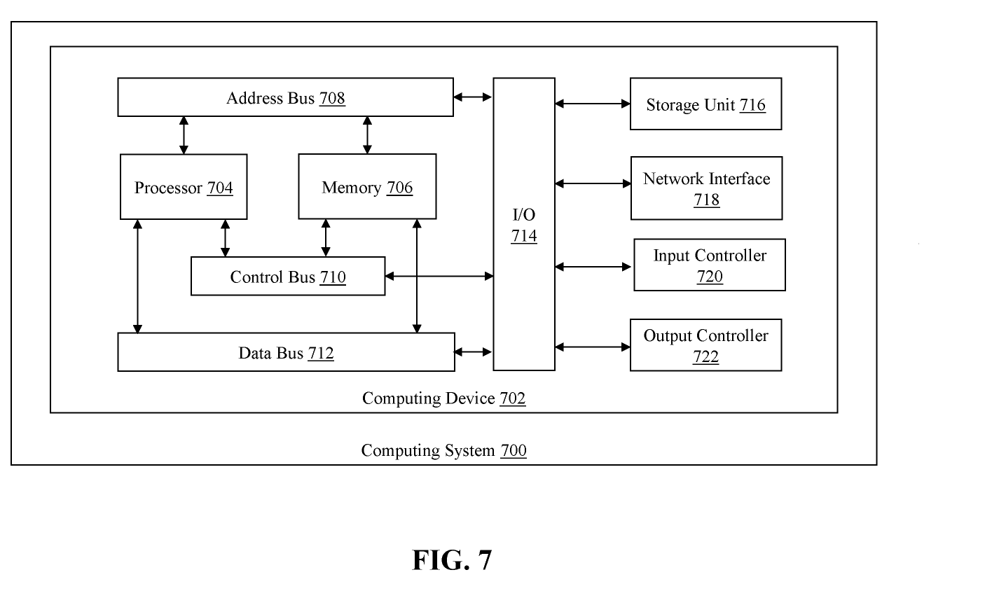

FIG. 7 shows an example computing system 700 for carrying out the methods of the present disclosure, consistent with disclosed embodiments of the present disclosure. Specifically, FIG. 7 shows a block diagram of an embodiment of the computing system 700 according to example embodiments of the present disclosure.

The computing system 700 may be configured to perform any of the operations disclosed herein. The computing system 700 may be implemented as a conventional computer system, an embedded controller, a laptop, a server, a mobile device, a smartphone, a customized machine, any other hardware platform, or any combination or multiplicity thereof. In one embodiment, the computing system 700 is a distributed system configured to function using multiple computing machines interconnected via a data network or bus system.

The computing system 700 includes computing devices (such as a computing device 702). The computing device 702 includes one or more processors (such as a processor 704) and a memory 706. The processor 704 may be any general-purpose processor(s) configured to execute a set of instructions. For example, the processor 704 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 704 may be multiple processing units, a single processing core, multiple processing cores, special purpose processing cores, co-processors, or any combination thereof. The processor 704 may be communicatively coupled to the memory 706 via an address bus 708, a control bus 710, and a data bus 712.

The memory 706 may include non-volatile memories such as a read-only memory (ROM), a programmable read-only memory (PROM), an erasable programmable read-only memory (EPROM), a flash memory, or any other device capable of storing program instructions or data with or without applied power. The memory 706 may also include volatile memories, such as a random-access-memory (RAM), a static random-access-memory (SRAM), a dynamic random-access-memory (DRAM), and a synchronous dynamic random-access-memory (SDRAM). The memory 706 may include single or multiple memory modules. While the memory 706 is depicted as part of the computing device 702, a person skilled in the art may recognize that the memory 706 may be separate from the computing device 702.

The memory 706 may store information that may be accessed by the processor 704. For instance, the memory 706 (e.g., one or more non-transitory computer-readable storage mediums, memory devices) may include computer-readable instructions (not shown) that may be executed by the processor 704. The computer-readable instructions may be software written in any suitable programming language or may be implemented in hardware. Additionally, or alternatively, the computer-readable instructions may be executed in logically and/or virtually separate threads on the processor 704. For example, the memory 706 may store instructions (not shown) that, when executed by the processor 704, cause the processor 704 to perform operations such as any of the operations and functions for which the computing system 700 is configured, as described herein. Additionally, or alternatively, the memory 706 may store data (not shown) that may be obtained, received, accessed, written, manipulated, created, and/or stored. The data may include, for instance, the data and/or information described herein in relation to FIGS. 1-6. In some implementations, the computing device 702 may obtain from and/or store data in one or more memory device(s) that are remote from the computing system 700.

The computing device 702 may further include an input/output (I/O) interface 714 communicatively coupled to the address bus 708, the control bus 710, and the data bus 712. The data bus 712 may include a plurality of tunnels that may support communication in the system environment 100. The I/O interface 714 is configured to couple to one or more external devices (e.g., to receive and send data from/to one or more external devices). Such external devices, along with the various internal devices, may also be known as peripheral devices. The I/O interface 714 may include both electrical and physical connections for operably coupling the various peripheral devices to the computing device 702. The I/O interface 714 may be configured to communicate data, addresses, and control signals between the peripheral devices and the computing device 702. The I/O interface 714 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 714 is configured to implement only one interface or bus technology. Alternatively, the I/O interface 714 is configured to implement multiple interfaces or bus technologies. The I/O interface 714 may include one or more buffers for buffering transmissions between one or more external devices, internal devices, the computing device 702, or the processor 704. The I/O interface 714 may couple the computing device 702 to various input devices, including touch screens, scanners, biometric readers, electronic digitizers, receivers, touchpads, cameras, keyboards, any other pointing devices, or any combinations thereof. The I/O interface 714 may couple the computing device 702 to various output devices, including printers, projectors, tactile feedback devices, automation control, robotic components, actuators, transmitters, signal emitters, lights, and so forth.

The computing system 700 may further include a storage unit 716, a network interface 718, an input controller 720, and an output controller 722. The storage unit 716, the network interface 718, the input controller 720, and the output controller 722 are communicatively coupled to the central control unit (e.g., the memory 706, the address bus 708, the control bus 710, and the data bus 712) via the I/O interface 714. The network interface 718 communicatively couples the computing system 700 to one or more networks such as wide area networks (WAN), local area networks (LAN), intranets, the Internet, wireless access networks, wired networks, mobile networks, telephone networks, optical networks, or combinations thereof. The network interface 718 may facilitate communication with packet-switched networks or circuit-switched networks, which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 716 is a computer-readable medium, preferably a non-transitory computer-readable medium, comprising one or more programs, the one or more programs comprising instructions which when executed by the processor 704 cause the computing system 700 to perform the method steps of the present disclosure. Alternatively, the storage unit 716 is a transitory computer-readable medium. The storage unit 716 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 716 stores one or more operating systems, application programs, program modules, data, or any other information. The storage unit 716 is part of the computing device 702. Alternatively, the storage unit 716 is part of one or more other computing machines that are in communication with the computing device 702, such as servers, database servers, cloud storage, network attached storage, and so forth.

The input controller 720 may include suitable logic, circuitry, interfaces, and/or code, executable by the circuitry, that may be configured to control one or more input devices that may be configured to receive the digital artifacts. The output controller 722 may include suitable logic, circuitry, interfaces, and/or code, executable by the circuitry, that may be configured to control one or more output devices that may be configured to output probability and confidence scores to manage the belief state.

In some embodiments, a computer-readable medium is disclosed. The computer-readable medium includes instructions that, when executed by processing circuitry that includes the processor 704 of the computing system 700, cause the computing system 700 to perform a method for management of belief spaces for the digital artifacts. The method comprises detecting an event associated with a first digital artifact of a set of digital artifacts. The set of digital artifacts is associated with the set of belief spaces with a belief space of the set of belief spaces including a set of belief types associated with a corresponding digital artifact of the set of digital artifacts and a set of belief states for the set of belief types. The set of digital artifacts and the set of belief spaces are stored in the storage element 116. The method further comprises accessing, based on the detection of the event, a first belief space associated with the first digital artifact. The method further comprises determining a plurality of attribute values for a plurality of attributes associated with the first digital artifact. The plurality of attribute values are indicative of operational metadata for a set of operations associated with the event. The method further comprises identifying from the first belief space, a first subset of belief types associated with the first digital artifact. The first subset of belief types is associated with a first subset of belief states that is to be updated based on the event. The method further comprises updating the first subset of belief states for the first subset of belief types based on the plurality of attribute values.

The disclosed system 102 offers significant advantages, including a dynamic and optimized approach in managing the belief spaces for the digital artifacts. The belief spaces (for example, the set of belief spaces 118) are updated based on real-time attribute values associated with the digital artifact through specific computational processes executed by the processing circuitry. The processing circuitry 114 creates a comprehensive and structured representation of a plurality of attributes associated with each digital artifact of the set of digital artifacts (for example, a first digital artifact of the set of digital artifacts 110) by embedding a plurality of functional attributes, a plurality non-functional, and a hidden attributes into a structured file formats, which facilitates complex decision making through probabilistic reasoning algorithms and multi-dimensional dependency analysis.

The inclusion of the plurality of hidden attributes into the structured file format may provide valuable insights into how developers interact with the digital artifact by capturing implicit behavioural data. This implementation leads to improved code quality metrics and more accurate decision making through enhanced belief state calculations.

The system 102 may support automation and scalability through the implementation of agentic and generative AI-based agents that execute specific computational tasks, including event processing, dependency analysis, and probability scoring. The processing circuitry 114 coordinates these agents to enable faster and more efficient management of belief spaces for the digital artifacts through sequential processing workflows and real-time belief state updates. The system benefits from improved adaptability, as the belief space management tasks may be dynamically tuned or reconfigured without hardware limitations through the agentic and generative AI-based agents executing machine-readable instructions, allowing the system 102 to maintain consistent performance across varying computational loads.

The set of logic constraints 120 stored in the storage element 116 enables conflict resolution and facilitates probability and confidence score generation through predetermined algorithms that facilitates decision-making operations executed by the processing circuitry 114.

The processing circuitry 114 identifies impacted belief spaces based on dependency analysis performed by the dependency analysis agent 208, which enables maintaining the belief spaces of each digital artifact of the set of digital artifacts 110 through automated propagation of updates across syntactic and semantic associations.

The belief space management system 102 enables intelligent, agile, and resource-efficient management of belief spaces for the digital artifacts while providing superior computational performance, thereby delivering enhanced operational flexibility and system throughput.

A person of ordinary skill in the art may appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for management of the belief spaces for the digital artifacts. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
a storage element configured to:
store a set of digital artifacts and a set of belief spaces associated with the set of digital artifacts, wherein a belief space of the set of belief spaces includes a set of belief types associated with a corresponding digital artifact of the set of digital artifacts and a set of belief states for the set of belief types; and
processing circuitry coupled to the storage element and configured to:
detect an event associated with a first digital artifact of the set of digital artifacts;
access, based on the detection of the event, a first belief space associated with the first digital artifact;
determine a first plurality of attribute values for a first plurality of attributes associated with the first digital artifact, wherein the first plurality of attribute values are indicative of first operational metadata for a set of operations associated with the event;
identify, from the first belief space, a first subset of belief types associated with the first digital artifact, wherein the first subset of belief types is associated with a first subset of belief states that is to be updated based on the event; and
update, based on the first plurality of attribute values, the first subset of belief states for the first subset of belief types.

2. The system of claim 1, wherein the storage element is further configured to store an event processing agent, and wherein the event processing agent is configured to:
monitor a second plurality of attribute values for the first plurality of attributes associated with the first digital artifact; and
determine, based on the monitoring, a transition of the second plurality of attribute values to the first plurality of attribute values, wherein the event is detected based on the transition of the second plurality of attribute values to the first plurality of attribute values.

3. The system of claim 2, wherein the storage element is further configured to store a belief state update agent, and wherein the belief state update agent is configured to:
receive, from the event processing agent, the first plurality of attribute values for the first plurality of attributes; and
determine, based on the first plurality of attribute values, the first operational metadata for the set of operations, wherein the first subset of belief types is identified based on the first operational metadata.

4. The system of claim 3,
wherein a first belief state of the first subset of belief states is indicative of a previous state of a first belief type of the first subset of belief types,
wherein the storage element is further configured to store a probability and confidence scoring agent configured to:
receive, from the belief state update agent, the first plurality of attribute values for the first plurality of attributes; and
determine, based on the first plurality of attribute values, at least one of: a probability score associated with a current state of the first belief type or a confidence score associated with the probability score, and
wherein the belief state update agent is further configured to:
receive, from the probability and confidence scoring agent, at least one of: the probability score associated with the current state of the first belief type or the confidence score associated with the probability score; and
update the first belief state based on at least one of: the probability score or the confidence score.

5. The system of claim 1, wherein the event is further associated with a second digital artifact of the set of digital artifacts, and wherein the processing circuitry is further configured to:
access, based on the detection of the event, a second belief space associated with the second digital artifact;
determine a second plurality of attribute values for a second plurality of attributes associated with the second digital artifact, wherein the second plurality of attribute values are indicative of second operational metadata for the set of operations associated with the event;
identify, from the second belief space, a second subset of belief types associated with the second digital artifact, wherein the second subset of belief types is associated with a second subset of belief states that is to be updated based on the event; and
update, based on the second plurality of attribute values, the second subset of belief states for the second subset of belief types.

6. The system of claim 1, wherein the storage element is further configured to store a dependency analysis agent, wherein the dependency analysis agent is configured to:
identify a third belief space associated with a third digital artifact of the set of digital artifacts, wherein the third belief space is identified based on an association of the third digital artifact with the first digital artifact, and
wherein the processing circuitry is further configured to:
access the third belief space associated with the third digital artifact;
determine a third plurality of attribute values for a third plurality of attributes associated with the third digital artifact, wherein the third plurality of attribute values are indicative of third operational metadata for the set of operations associated with the event;
identify, from the third belief space, a third subset of belief types associated with the third digital artifact, wherein the third subset of belief types is associated with a third subset of belief states that is to be updated based on the event; and
update, based on the third plurality of attribute values, the third subset of belief states for the third subset of belief types.

7. The system of claim 6, wherein the association of the third digital artifact with the first digital artifact corresponds to at least one of: a syntactic association or a semantic association.

8. The system of claim 6, wherein the dependency analysis agent is further configured to:
create a dependency graph based on the set of belief spaces, wherein the dependency graph is indicative of an association of the first belief space with the third belief space based on the first digital artifact being associated with the third digital artifact; and
determine the association of the third belief space with the first belief space based on the dependency graph.

9. The system of claim 1, wherein the first plurality of attributes corresponds to at least one of: a plurality of functional attributes associated with the first digital artifact, a plurality of non-functional attributes associated with the first digital artifact, or a plurality of hidden attributes associated with the first digital artifact.

10. The system of claim 1, wherein the processing circuitry is further configured to:
create a standard format file for the first digital artifact;
determine a fourth plurality of attribute values for the first plurality of attributes associated with the first digital artifact;
generate, for the first digital artifact, a structured file format based on at least one of: the standard format file and the fourth plurality of attribute values, wherein the first belief space is created based on the generated structured file format; and
store the first belief space in the storage element.

11. The system of claim 1, wherein the storage element is further configured to store a set of logic constraints, and wherein the first subset of belief states is updated further based on the set of logic constraints.

12. A method, comprising:
detecting, by processing circuitry, an event associated with a first digital artifact of a set of digital artifacts, wherein the set of digital artifacts is associated with a set of belief spaces with a belief space of the set of belief spaces including a set of belief types associated with a corresponding digital artifact of the set of digital artifacts and a set of belief states for the set of belief types, and wherein the set of digital artifacts and the set of belief spaces are stored in a storage element;
accessing, by the processing circuitry, based on the detection of the event, a first belief space associated with the first digital artifact;
determining, by the processing circuitry, a first plurality of attribute values for a first plurality of attributes associated with the first digital artifact, wherein the first plurality of attribute values are indicative of first operational metadata for a set of operations associated with the event;
identifying, by the processing circuitry, from the first belief space, a first subset of belief types associated with the first digital artifact, wherein the first subset of belief types is associated with a first subset of belief states that is to be updated based on the event; and
updating, by the processing circuitry, the first subset of belief states for the first subset of belief types based on the first plurality of attribute values.

13. The method of claim 12, further comprising:
monitoring, by an event processing agent stored in the storage element, a second plurality of attribute values for the first plurality of attributes associated with the first digital artifact; and
determining, by the event processing agent, based on the monitoring, a transition of the second plurality of attribute values to the first plurality of attribute values, wherein the event is detected based on the transition of the second plurality of attribute values to the first plurality of attribute values.

14. The method of claim 13, further comprising:
receiving, by a belief state update agent stored in the storage element, the first plurality of attribute values for the first plurality of attributes from the event processing agent; and
determining, by the belief state update agent, based on the first plurality of attribute values, the first operational metadata associated with the set of operations, wherein the first subset of belief types is identified based on the first operational metadata.

15. The method of claim 14, further comprising:
receiving, by a probability and confidence scoring agent stored in the storage element, from the belief state update agent, the first plurality of attribute values for the first plurality of attributes;
determining, by the probability and confidence scoring agent, based on the first plurality of attribute values, at least one of: a probability score associated with a current state of a first belief type of the first subset of belief types or a confidence score associated with the probability score, wherein a first belief state of the first subset of belief states is indicative of a previous state of the first belief type;
receiving, by the belief state update agent, from the probability and confidence scoring agent, at least one of: the probability score associated with the current state of the first belief type or the confidence score associated with the probability score; and
updating, by the belief state update agent, the first belief state based on at least one of: the probability score or the confidence score.

16. The method of claim 12, further comprising:
identifying, by a dependency analysis agent stored in the storage element, a third belief space associated with a third digital artifact of the set of digital artifacts, wherein the third belief space is identified based on an association of the third digital artifact with the first digital artifact;
accessing, by the processing circuitry, the third belief space associated with the third digital artifact;
determining, by the processing circuitry, a third plurality of attribute values for a third plurality of attributes associated with the third digital artifact, wherein the third plurality of attribute values are indicative of third operational metadata for the set of operations associated with the event;
identifying, by the processing circuitry, from the third belief space, a third subset of belief types associated with the third digital artifact, wherein the third subset of belief types is associated with a third subset of belief states that is to be updated based on the event; and
updating, by the processing circuitry, based on the third plurality of attribute values, the third subset of belief states for the third subset of belief types.

17. The method of claim 16, wherein the association of the third digital artifact with the first digital artifact corresponds to at least one of: a syntactic association or a semantic association.

18. The method of claim 16, further comprising:
creating, by the dependency analysis agent, a dependency graph based on the set of belief spaces, wherein the dependency graph is indicative of an association of the first belief space with the third belief space based on the first digital artifact being associated with the third digital artifact; and
determining, by the dependency analysis agent, the association of the third belief space with the first belief space based on the dependency graph.

19. The method of claim 12, wherein the first plurality of attributes corresponds to at least one of: a plurality of functional attributes associated with the first digital artifact, a plurality of non-functional attributes associated with the first digital artifact, or a plurality of hidden attributes associated with the first digital artifact.

20. A non-transitory computer-readable medium comprising instructions that, when executed by processing circuitry of a computing system, cause the computing system to perform a method for managing a set of belief spaces, the method comprising:
detecting an event associated with a first digital artifact of a set of digital artifacts, wherein the set of digital artifacts is associated with the set of belief spaces with a belief space of the set of belief spaces including a set of belief types associated with a corresponding digital artifact of the set of digital artifacts and a set of belief states for the set of belief types, and wherein the set of digital artifacts and the set of belief spaces are stored in a storage element;
accessing, based on the detection of the event, a first belief space associated with the first digital artifact;
determining a plurality of attribute values for a plurality of attributes associated with the first digital artifact, wherein the plurality of attribute values are indicative of operational metadata for a set of operations associated with the event;
identifying, from the first belief space, a first subset of belief types associated with the first digital artifact, wherein the first subset of belief types is associated with a first subset of belief states that is to be updated based on the event; and
updating, based on the plurality of attribute values, the first subset of belief states for the first subset of belief types.
